(19) United States
(12) Patent Application Publication
(10) Pub. No.: US 2012/0034591 A1
(43) Pub. Date: Feb. 9, 2012

(54) STUDENT PERFORMANCE ASSESSMENT

(75) Inventors: H. Ogden Morse, III, Falmouth, ME (US); H. Ogden Morse, JR., Redding, CT (US); Timothy P. Brooks, Portland, ME (US)

(73) Assignee: ACADEMICMERIT, LLC, Portland, ME (US)

(21) Appl. No.: 13/197,567

(22) Filed: Aug. 3, 2011

Related U.S. Application Data
(60) Provisional application No. 61/370,668, filed on Aug. 4, 2010.
(60) Provisional application No. 61/370,674, filed on Aug. 4, 2010.
(60) Provisional application No. 61/479,093, filed on Apr. 26, 2011.

(51) Int. Cl. G09B 7/00

(52) U.S. Cl. 434/353

(57) ABSTRACT

Described are computer-based methods and apparatuses, including computer program products, for student performance assessment. In some examples, a method includes automatically generating an assessment for a plurality of students based on a selection of assessment information; receiving a plurality of assessment responses from the plurality of students in response to the generated assessment; transmitting requests for at least two preliminary assessment scores for each of the plurality of assessment responses; receiving at least two preliminary assessment scores for each of the plurality of assessment responses; determining if each of the at least two preliminary assessment scores for each of the assessment responses match a criteria; transmitting a request for an additional preliminary assessment score for the assessment response if the at least two preliminary assessment scores match the criteria; and generating a final assessment score for each of the assessment responses.

### RELATED APPLICATIONS

This application claims the benefit of U.S. Provisional Application No. 61/370,668, filed on Aug. 4, 2010 and entitled “Assessing Student Performance and Generating Metrics,” U.S. Provisional Application No. 61/370,674, filed on Aug. 4, 2010 and entitled “Student Performance Scoring System and Method,” and U.S. Provisional Application No. 61/479,093, filed on Apr. 26, 2011 and entitled “Teacher Scoring System and Method.” The entire teachings of the above applications are incorporated herein by reference.

### BACKGROUND

The primary objective of English Language Arts teachers in grades 7-12 is improving their students' reading-comprehension and writing skills. To do so, they—and their school- and district-level administrators—need assessment vehicles that generate data that accurately measure their students' classroom-based performance in these subject areas on an ongoing basis. The problem, however, is that, at present, both teachers and administrators lack this sort of data; instead, they must rely on state or national exams that are administered once per year—and that require delays of weeks or months before the data is available. Thus, there is a need in the art for an improved computerized student performance assessment.

### SUMMARY

One approach is a method for student performance assessment. The method includes automatically generating, via a processor, an assessment for a plurality of students based on a selection of assessment information; receiving, via the processor, a plurality of assessment responses from the plurality of students in response to the generated assessment; transmitting, via the processor, requests for at least two preliminary assessment scores for each of the plurality of assessment responses; receiving, via the processor, at least two preliminary assessment scores for each of the plurality of assessment responses; determining, via the processor, if each of the at least two preliminary assessment scores for each of the assessment responses match a criteria; transmitting, via the processor, a request for an additional preliminary assessment score for the assessment response if the at least two preliminary assessment scores match the criteria; and generating, via the processor, a final assessment score for each of the assessment responses based on the at least two preliminary assessment scores for each of the plurality of assessment responses, the additional preliminary assessment score for each of the plurality of assessment responses, or any combination thereof.

Another approach is a computer program product, tangibly embodied in an information carrier. The computer program product includes instructions being operable to cause a data processing apparatus to generate an assessment for a plurality of students based on a selection of assessment information; receive a plurality of assessment responses from the plurality of students in response to the generated assessment; transmit requests for at least two preliminary assessment scores for each of the plurality of assessment responses; receive at least two preliminary assessment scores for each of the plurality of assessment responses; determine if each of the at least two preliminary assessment scores for each of the assessment responses match a criteria; transmit a request for an additional preliminary assessment score for the assessment response if the at least two preliminary assessment scores match the criteria; and generate a final assessment score for each of the assessment responses based on the at least two preliminary assessment scores for each of the plurality of assessment responses, the additional preliminary assessment score for each of the plurality of assessment responses, or any combination thereof.

Another approach is a system for student performance assessment. The system includes an assessment generation module configured to generate an assessment for a plurality of students based on a selection of assessment information; a communication module configured to: receive a plurality of assessment responses from the plurality of students in response to the generated assessment, transmit requests for at least two preliminary assessment scores for each of the plurality of assessment responses, receive at least two preliminary assessment scores for each of the plurality of assessment responses, and transmit a request for an additional preliminary assessment score for the assessment response if the at least two preliminary assessment scores match a criteria; a score determination module configured to determine if each of the at least two preliminary assessment scores for each of the assessment responses match the criteria; and a final score module configured to generate a final assessment score for each of the assessment responses based on the at least two preliminary assessment scores for each of the plurality of assessment responses, the additional preliminary assessment score for each of the plurality of assessment responses, or any combination thereof.

In some examples, any of the approaches above can include one or more of the following features.

In some examples, the method further includes wherein one of the at least two preliminary assessment scores for each of the plurality of assessment responses is associated with a teacher; determining if the one of the at least two preliminary assessment scores associated with the teacher matches a pre-determined assessment score associated with the assessment response; and generating development information associated with the teacher based on the preliminary assessment score that matches the pre-determined assessment score.

In some examples, the method further includes transmitting a request to the teacher for an additional assessment score of an additional student assessment based on the determination of the one of the at least two preliminary assessment score that matches the pre-determined assessment score; receiving the additional assessment score associated with the additional student assessment, the additional assessment score associated with the teacher; determining if the additional assessment score associated with the additional student assessment matches a pre-determined assessment score associated with the additional student assessment; and modifying the development information associated with the teacher based on the additional assessment score that matches the pre-determined assessment score.

In some examples, the final assessment score is a performance score for classroom-based performance of a student in the plurality of students.

In some examples, the assessment comprises a text, at least one reading comprehension question associated with a text, at least one essay question associated with a text, or any combination thereof.

In some examples, the method further includes automatically generating at least one scoring assessment metric based on the final assessment score for each of the assessment responses, one or more stored assessment scores, one or more stored historical assessment statistics, or any combination thereof.

In some examples, the at least one scoring assessment metric is a performance metric for classroom-based performance of the plurality of students.

In some examples, automatically generating the assessment for the plurality of students based on the selection of assessment information further comprises automatically generating the assessment for the plurality of students based on the selection of assessment information and the at least one scoring assessment metric.

In some examples, automatically generating the assessment for the plurality of students based on the selection of assessment information further comprises automatically generating the assessment for the plurality of students based on the selection of assessment information and at least one stored assessment score.

In some examples, each preliminary assessment score is received from a different scorer selected from a plurality of scorers.

In some examples, the teacher is one of the different scorers selected from the plurality of scorers.

In some examples, the method further includes automatically selecting the different scorer from a plurality of scorers based on a plurality of assessments associated with each scorer of the plurality of scorers.

In some examples, automatically selecting the different scorer from the plurality of scorers based on the plurality of assessments further comprises automatically and randomly selecting the different scorer from a plurality of scorers based on the plurality of assessments.

In some examples, the final assessment score comprise a plurality of scores, each score associated with a part of the assessment.

In some examples, the method further includes generating the criteria based on the at least two preliminary assessment scores for each of the assessment responses, one or more stored assessment scores, one or more stored historical assessment statistics, or any combination thereof.

In some examples, the system further includes one of the at least two preliminary assessment scores for each of the plurality of assessment responses is associated with a teacher; a teacher score module configured to determine if the one of the at least two preliminary assessment scores associated with the teacher matches a pre-determined assessment score associated with the assessment response; and a teacher development module configured to generate development information associated with the teacher based on the preliminary assessment score that matches the pre-determined assessment score.

In some examples, the system further includes the communication module further configured to transmit a request to the teacher for an additional assessment score of an additional student assessment based on the determination of the one of the at least two preliminary assessment score that matches the pre-determined assessment score, and receive the additional assessment score associated with the additional student assessment, the additional assessment score associated with the teacher; the teacher score module further configured to determine if the additional assessment score associated with the additional student assessment matches a pre-determined assessment score associated with the additional student assessment; and the teacher development module further configured to modify the development information associated with the teacher based on the additional assessment score that matches the pre-determined assessment score.

In some examples, the system further includes a metric generation module configured to generate at least one scoring assessment metric based on the final assessment score for each of the assessment responses, one or more stored assessment scores, one or more stored historical assessment statistics, or any combination thereof.

The student performance assessment techniques described herein can provide one or more of the following advantages. An advantage of the technology is the ability to calibrate teacher evaluations of student writing based on a universal set of criteria, thereby enabling the teachers to align scoring based on a standard which increases the efficiency of the scoring and evaluation process. Another advantage of the technology is the ability to align teacher evaluations with other evaluations which results in consistent expectations for students, thereby increasing the efficiency of the learning process for the students. Another advantage of the technology is the administration of summative assessments in the classroom for the generation of data that can be utilized by teachers for instruction purposes and/or by administrators for decision-making purposes, thereby increasing the efficiency of the learning process by providing consistent, real-time information. Another advantage of the technology is the “double-blind” scoring of student assessments which produces objective and consistent results, thereby increasing the efficiency of student learning.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIGS. 1A-1C illustrate a flowchart depicting an exemplary assessment of student performance and generation of metrics;

FIGS. 2A-2D illustrate a flowchart depicting an exemplary scoring of student performance;

FIGS. 3A-3W illustrate screenshots of exemplary user interfaces for the technology;

FIG. 4 is a block diagram illustrating an exemplary configuration for assessing students;

FIG. 5 illustrates an exemplary computing device;

FIG. 6 illustrates an exemplary student assessment server;

FIG. 7 is a flowchart illustrating an exemplary method for assessment of student performance;

FIG. 8 is a flowchart illustrating an exemplary method for generation of metric(s) based on student performance;

FIG. 9 is a flowchart illustrating an exemplary scoring of student performance; and

FIG. 10 is a flowchart illustrating an exemplary scoring of teacher performance.

### DETAILED DESCRIPTION

Student performance assessment techniques include, for example, computerized technology for evaluating student writing based on a universal set of criteria. The technology can provide automated generation of student assessments (e.g., assign a short essay and a set of questions to a class) and evaluation of student responses to the assessments (e.g., short answer, essay) utilizing an automated “double-blind” scoring mechanism (e.g., at least two scorers score each student response and the technology processes the scores for consistency). The evaluation of student writing can be based on a universal set of criteria can enable the generation of consistent scores for the students (e.g., the students understand the writing expectations), the teachers (e.g., the teachers understand what is required of the students), and the school administrators (e.g., the school administrators can compare students scores with other students scores on a consistent basis). The technology can automatically generate teacher development information (e.g., teacher training hand-outs, multimedia training video) based on a teacher's scoring of a student response compared to standardized scoring of the student response. The technology can automatically train teachers to consistently score (e.g., use category-by-category comparative scoring and analysis, answer by answer corrective feedback) the student responses to the assessments utilizing the universal set of criteria.

The student performance assessment techniques include computerized technology for assessing student performance and generating metrics, student performance scoring systems and methods, and/or teacher scoring systems and methods. The technology, generally, enables the automated generation of assessments for students, the automated scoring of the student responses to the assessments, and/or the automated generation of teacher development information based on teacher scoring of the student responses. The technology advantageously provides an efficient mechanism of automatically administrating summative assessments of student performance in reading comprehension and written analysis in the classroom that can be utilized by teachers and/or school administrators to see, in real-time, how students are performing in these areas throughout the school year. The technology advantageously enables teachers and/or school administrators to analyze historical data regarding student performance in reading comprehension and written analysis to enable them to determine classroom performance over a period of time (e.g., month to month, year to year).

The technology described herein for assessing student performance and generating metrics (also referred to as Assessments21® student performance software, developed by AcademicMerit) is a computer-based application (e.g., Web-based application, client server based application) that enables: (1) teachers to search for and select common assessments in reading comprehension and written analysis from a library featuring poems, short stories, and non-fiction texts representing at least three levels of difficulty; (2) teachers to choose when and how often to administer the assessments in their classrooms; (3) trained readers (also referred to as scorers) to conduct double-blind scoring of each essay upon submission to a centralized online database; and/or (4) students, teachers, and administrators to receive the results online immediately upon completion of the double-blind scoring.

The technology described herein for a student performance scoring system and method (also referred to as the Centralized Online Scoring System for Writing (COSS) student scoring software, developed by AcademicMerit) includes a process that enables student writing to be evaluated objectively and quantifiably, and to generate detailed data that can be used by teachers and schools to enhance learning and instruction. The technology enables the writing assessments to be administered in the classroom as frequently as desired, and for the assessments to be scored—anonymously—by trained readers or teachers (also referred to as scorers or graders).

The technology described herein for a teacher scoring system and method (also referred to as FineTune™ teacher development software, developed by AcademicMerit) includes a process that provides an online professional-development tool that enables teachers to score authentic students' essays using a writing rubric (e.g., five-category writing rubric, ten-category writing rubric) and then receive immediate feedback on the scores the teachers submitted. The technology advantageously enables teachers to calibrate their evaluation of student essays with the universal set of criteria represented by the rubric. The technology advantageously provides supervisors (also referred to as school administrators) with data to further support teachers (e.g., develop focused professional development, send focused development materials). The technology advantageously enables teachers to calibrate their evaluation of student essays with their colleagues (e.g., using the universal set of criteria, by receiving the same training).

In some examples, the teacher scoring system and method integrates with the student performance scoring system and method to enable teachers to practice calibrating their scoring with the writing rubric. In this example, if a teacher's scoring is calibrated with the writing rubric, the teacher is approved as a scorer (also referred to as a reader). The technology can, for example, associate the approved scorers with the assessments for scoring utilizing the student performance scoring system and method.

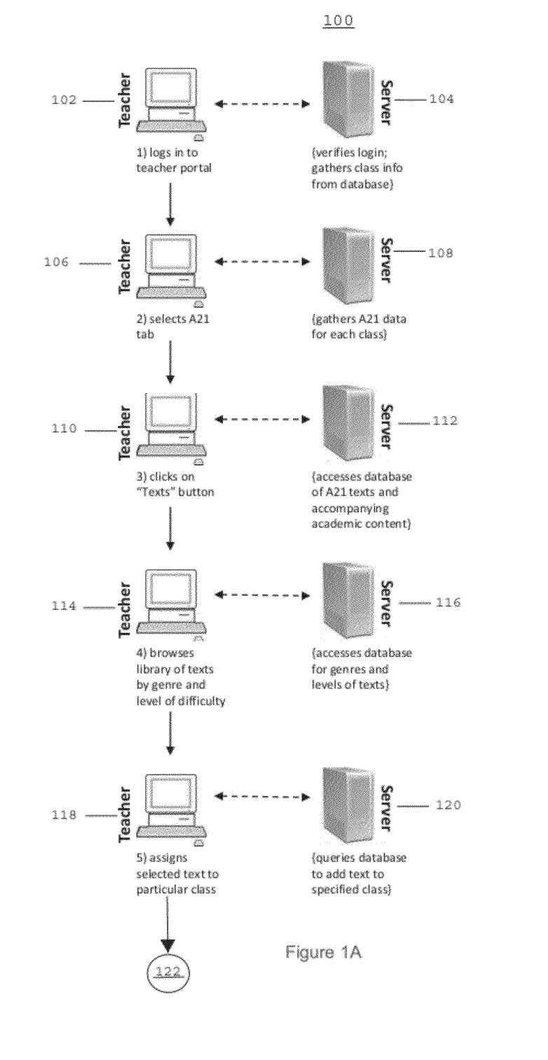

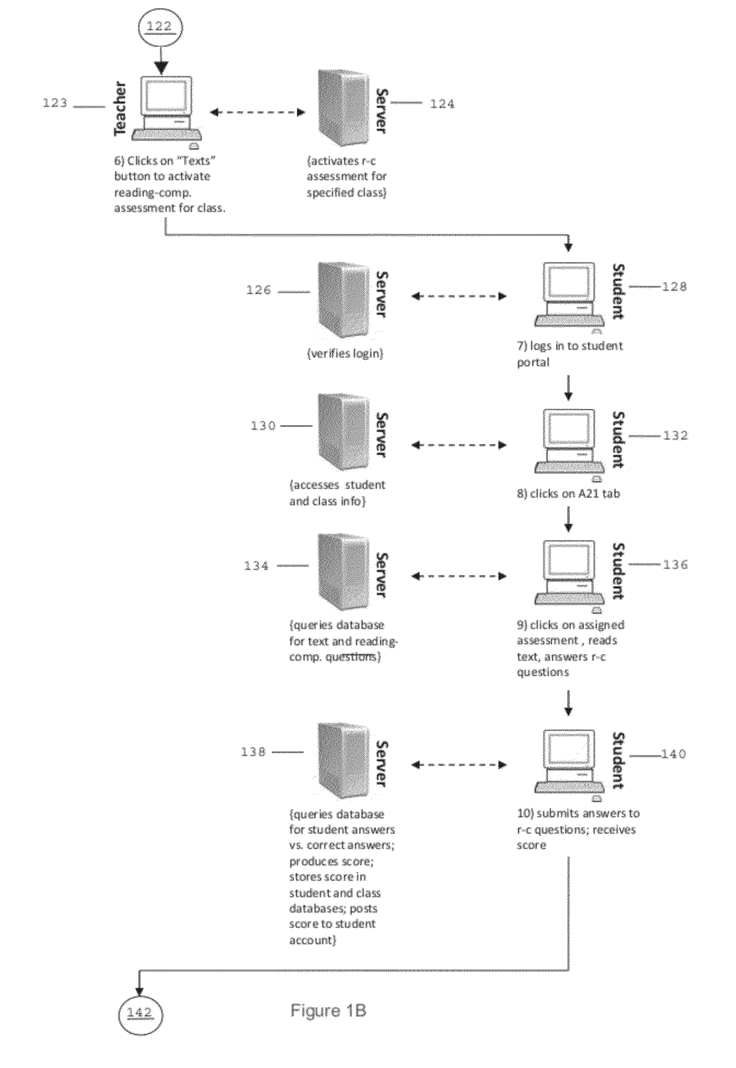

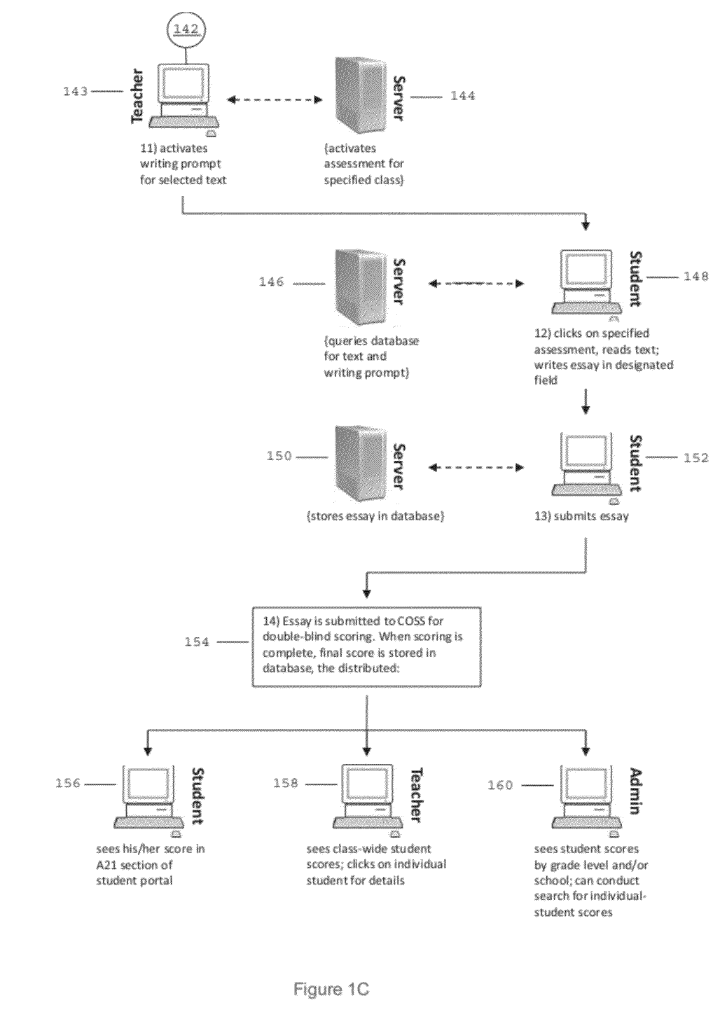

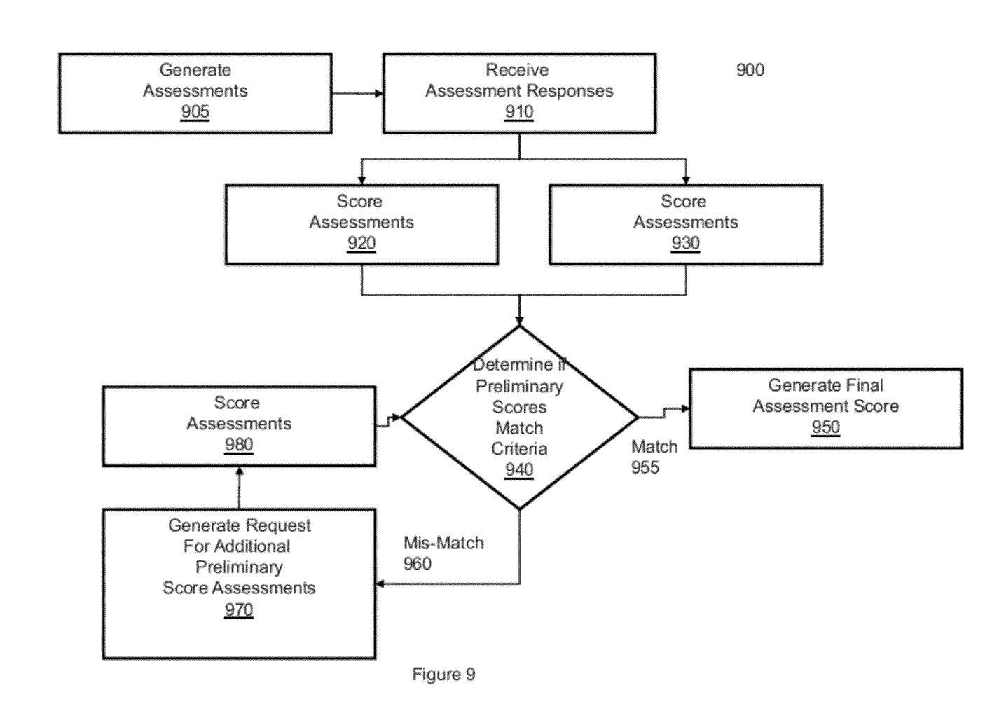

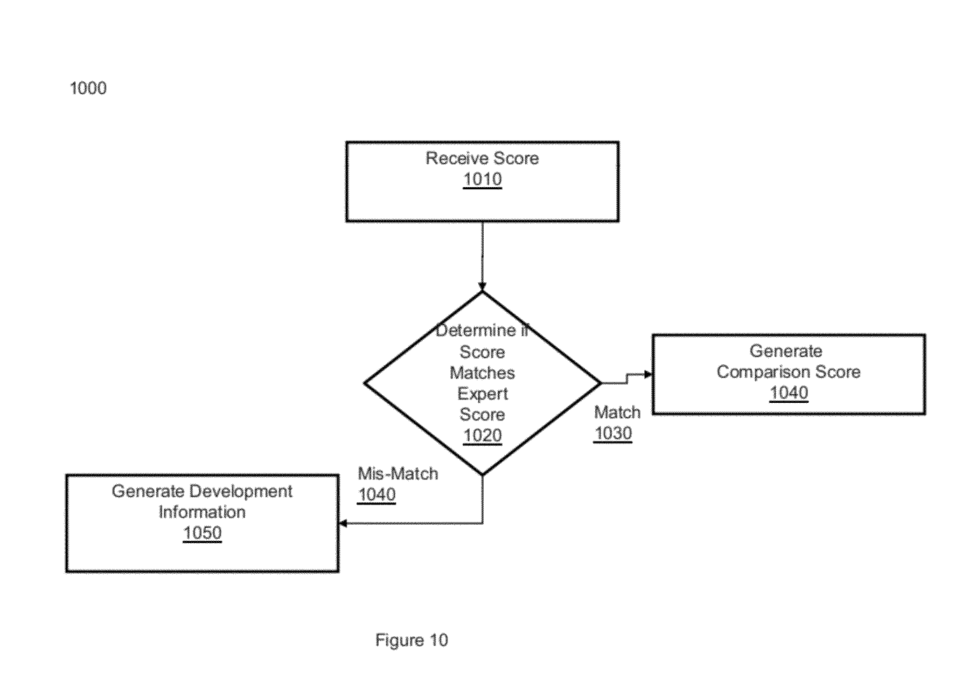

FIGS. 1A-1C, 2A-2D, and 3A-3W illustrate exemplary student performance assessment techniques from the viewpoint of the students, teachers, and/or administrators. FIGS. 1A-1C, 2A-2D, and 3A-3W illustrate exemplary processes that can utilize any of the computing devices and/or servers (e.g., student assessment server), as described herein. FIGS. 9-10 illustrate exemplary student performance assessment techniques from the viewpoint of servers (e.g., student assessment server), as described herein.

FIGS. 1A-1C illustrate a flowchart 100 depicting an exemplary assessment of student performance and the generation of related metrics. As illustrated in FIGS. 1A-1C, the processing is executed by a teacher computing device, a server, a student computing device, and/or an administrator computing device. A teacher, utilizing the teacher computing device, logs (102) into a teacher portal. The server verifies (104) the login and gathers classroom information associated with the teacher from the database (e.g., database within the server, database separate from the server). The teacher, utilizing the teacher computing device, selects (106) the A21 tab in the teacher portal. The server gathers (108) A21 data for each class associated with the teacher. The teacher, utilizing the teacher computing device, accesses (110) the available texts (e.g., short essay, book) for the class by clicking on the “Texts” button. The server accesses (112) a database of A21 texts and accompanying academic content (e.g., open-ended questions, closed-ended questions, expert commentary). The teacher, utilizing the teacher computing device, browses (114) the library of texts by genre and/or level of difficulty.

The server accesses (116) the database for genres and/or levels of texts. The teacher, utilizing the teacher computing device, assigns (118) one or more selected texts (part or all of an assessment) to a particular class associated with the teacher. The server queries (120) the database to associate the selected text with the specified class. The flowchart continues (122). The teacher, utilizing the teacher computing device, actives (123) the reading comprehension assessment for the class (part or all of the assessment) by clicking on the “Texts” button. The server activates (124) the assessment for the specified class.

A student, utilizing the student computing device, logs (128) into a student portal. The server verifies (126) the student login. The student, utilizing the student computing device, clicks (132) on the A21 tab. The server accesses (130) student and classroom information associated with the student to provide the information to the student computing device. The student, utilizing the student computing device, clicks (136) on the assigned assessment, reads the text, and answers the reading comprehension questions. The server queries (134) the database for text and reading comprehension questions. The student, utilizing the student computing device, submits (140) answers to the reading comprehension questions. The server queries (138) the database and determines if the student answers are correct. The server produces a score for the student, stores the scores in the student and classroom databases, and posts the score to the student's account. The flowchart continues (142).

The teacher, utilizing the teacher computing device, activates (143) a writing prompt for the selected text for the student to input an answer. The server activates (144) an assessment for the specified class based on the teacher's selection. The student, utilizing the student computing device, clicks (148) on the specified assessment, reads the text, and writes an essay in the designated field. The server queries (146) the database for a text and writing prompt to provide the text and writing prompt to the student computing device. The student, utilizing the student computing device, submits (152) the essay. The server stores (150) the essay in the database. The server submits (154) the essay to one or more computing devices for scoring by scorers and when scoring is completed, stores the final assessment score in the database. The student, utilizing the student computing device, views (156) his/her score in the A21 section of the student portal. The teacher, utilizing the teacher computing device, views (158) the class-wide student scores and/or the individual student score details. An administrator, utilizing the administrator computing device, views (160) the student scores by grade level and/or school and/or the individual student score details.

Although FIGS. 1A-1C illustrate an exemplary flowchart, the processing of data can be, for example, modified based on the assessment of student performance, generation of metrics, and/or any analysis based on the same. For example, the server can iteratively and automatically require a student to complete additional assessments (e.g., a multiple-choice question, an essay question) based on the student's previous performance on the assessments.

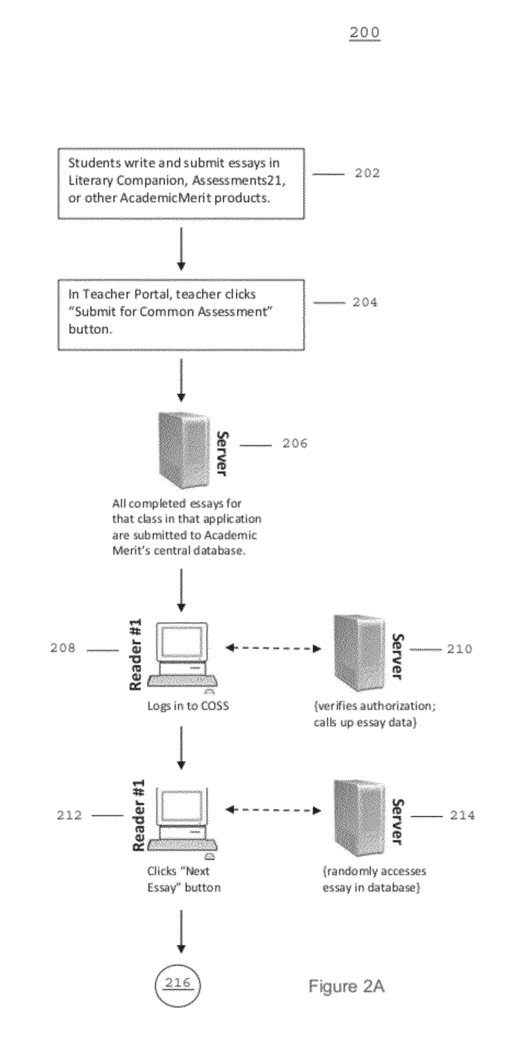

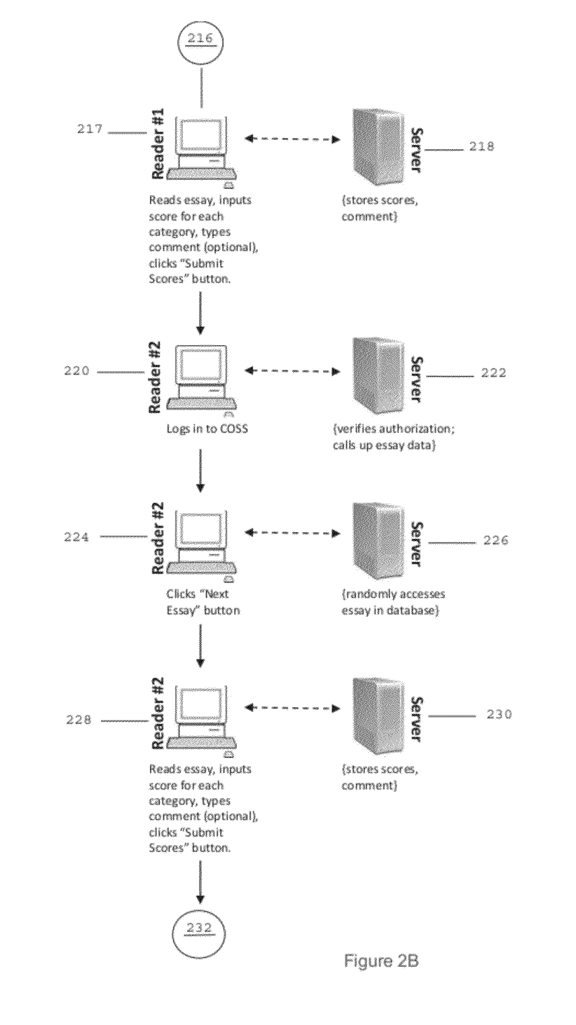

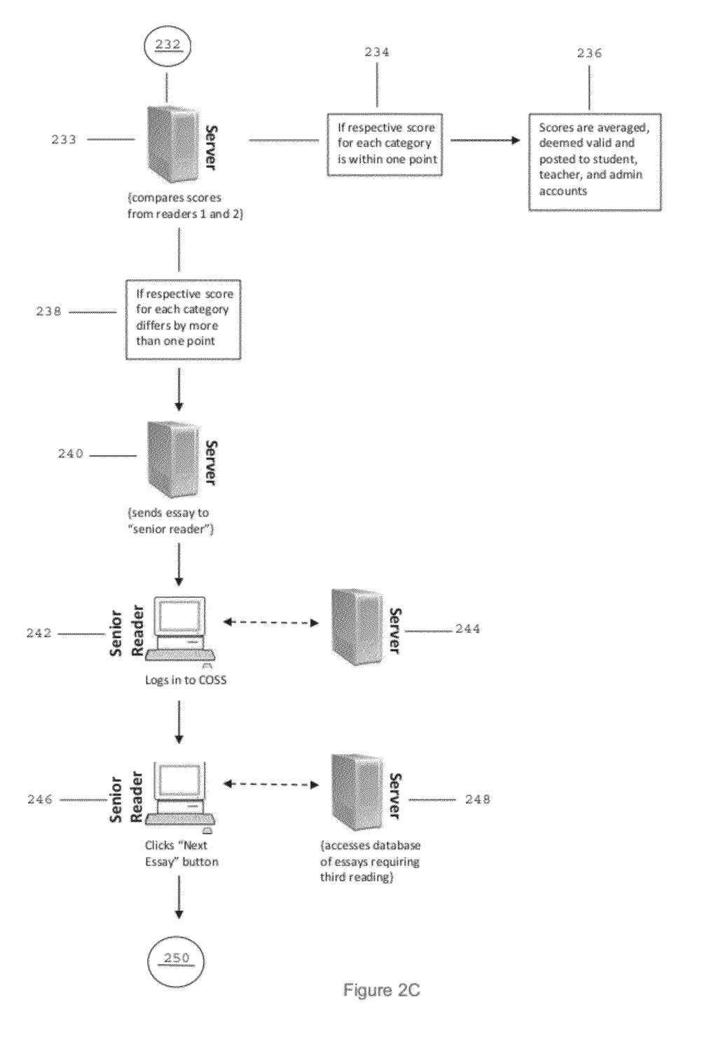

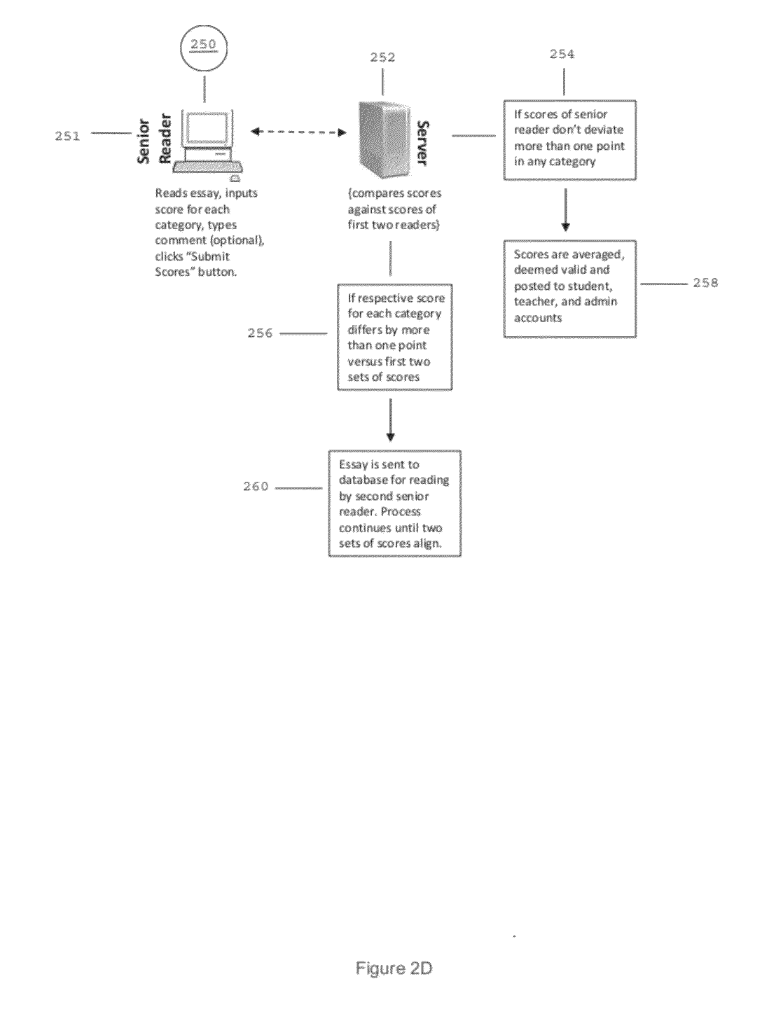

FIGS. 2A-2D illustrate a flowchart 200 depicting an exemplary scoring of student performance. The processing of the flowchart is executed by reader computing devices and a server. As described herein, the students, utilizing student computing devices, write and submit (202) assessments for scoring (e.g., as illustrated in FIGS. 1A-1C). The teacher, utilizing the teacher computing device, submits (204) the assessments for scoring (also referred to as responses to the assessments) by clicking “Submit for Common Assessment” button. The server submits (206) the completed assessments to the database for scoring. A first reader, utilizing a reader computing device, logs (208) into the server. The server verifies (210) authorization and retrieves the assessments from the database. The first reader, utilizing the reader computing device, clicks (212) on a “Next Essay” button in the reader portal. The server randomly accesses (214) the assessment for scoring in the database. The flowchart continues (216).

The first reader, utilizing the reader computing device, reads (217) the assessment, inputs a score for each category and/or types any optional comments. The server stores (218) the scores and/or comments. A second reader, utilizing another reader computing device, logs (220) into the technology. The server verifies (222) authorization and retrieves the assessments from the database. The second reader, utilizing the other reader computing device, clicks (224) on a “Next Essay” button in the reader portal. The server randomly accesses (226) an assessment in the database. The second reader, utilizing the other reader computing device, reads (228) the assessment, inputs a score for each category and/or types any optional comments. The server stores (230) the scores and/or comments. The flowchart continues (232).

The server compares (233) the scores provided by the first reader and the second reader. The server determines (234) if the respective scores for each category are within a specified range (e.g., one point on a hundred point scale, five points on a ten point scale). The server averages (236) the scores if the scores are within the specified range and posts the average score to the student portal, the teacher portal, and the administrative portal via the database. If the scores are not within (238) the specified range, the server sends (240) the assessment to a senior reader for scoring. The senior reader, utilizing a third reader computing device, logs (242) into the technology. The server verifies (244) authorization and retrieves the assessments to be scored by the senior reader from the database. The senior reader, utilizing the third reader computing device, clicks (246) on a “Next Essay” button in the reader portal. The server accesses (248) the database of essays requiring a third scoring. The flowchart continues (250).

The senior reader, utilizing the third reader computing device, reads (251) the assessment, inputs a score for each category and/or types any optional comments. The server compares (252) the senior reader's score with the scores from the first reader and the second reader. If the scores of the senior reader are within a specified range (e.g., one point, two points) in any category from the first reader or the second reader's scores (254), the server averages (258) the respective scores within the specified range and posts the average score to the student portal, the teacher portal, and the administrative portal. If the scores of the senior reader are not within the specified range in any category from the first reader or the second reader's scores (256), the server submits (260) the assessment to a database for scoring by another senior reader. This scoring process continues until two sets of score are within the specified range.

In some examples, the senior reader, utilizing the third reader computing devices, reads (251) the assessment, inputs a score for each category and/or types any optional comments. In this example, the server posts the senior reader's scores to the student portal, the teacher portal, and the administrative portal. In other words, in this example, the senior reader's scores are the final scores for the assessment.

Although FIGS. 2A-2D illustrate an exemplary flowchart, the processing of data can be, for example, modified based on the scoring parameters, assessment of student performance, teacher evaluation, and/or any other analysis. For example, the server can iteratively and automatically require a re-scoring of student performance based on the previous scoring (e.g., based on a grade level evaluation of the assessment, based on a statistical analysis of the scores, etc.).

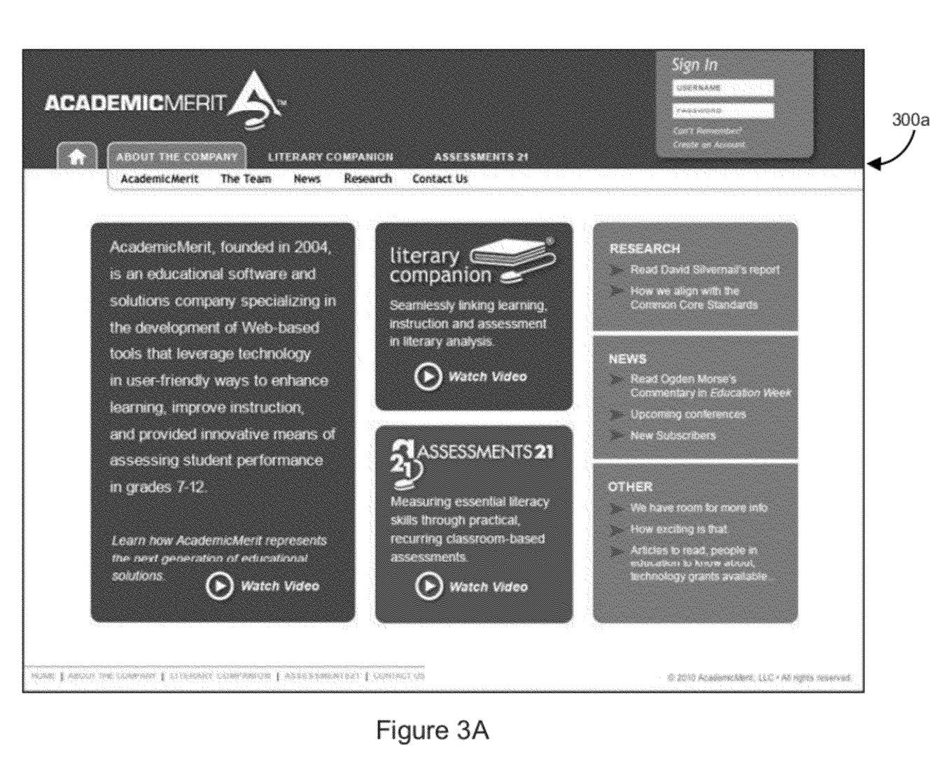

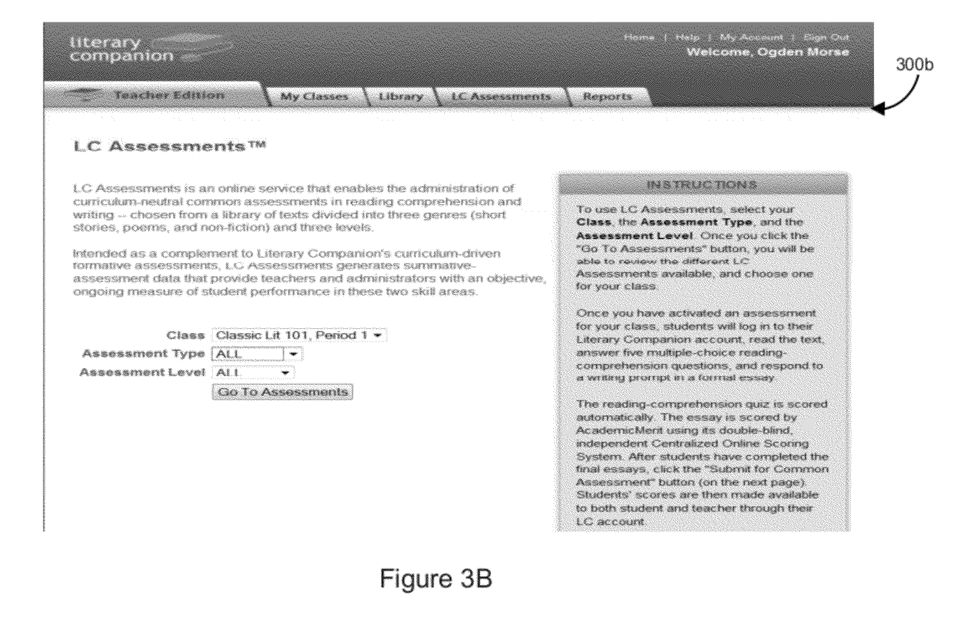

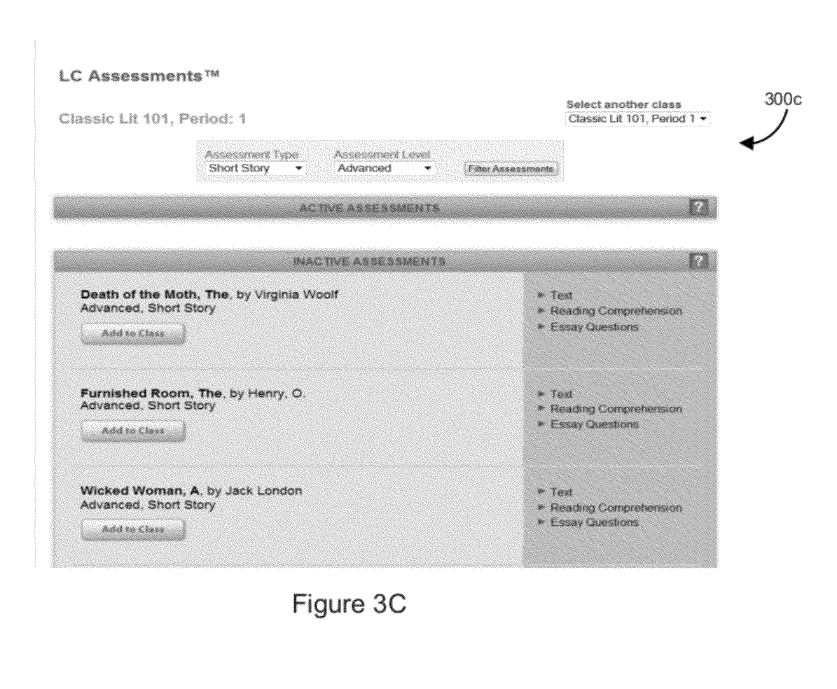

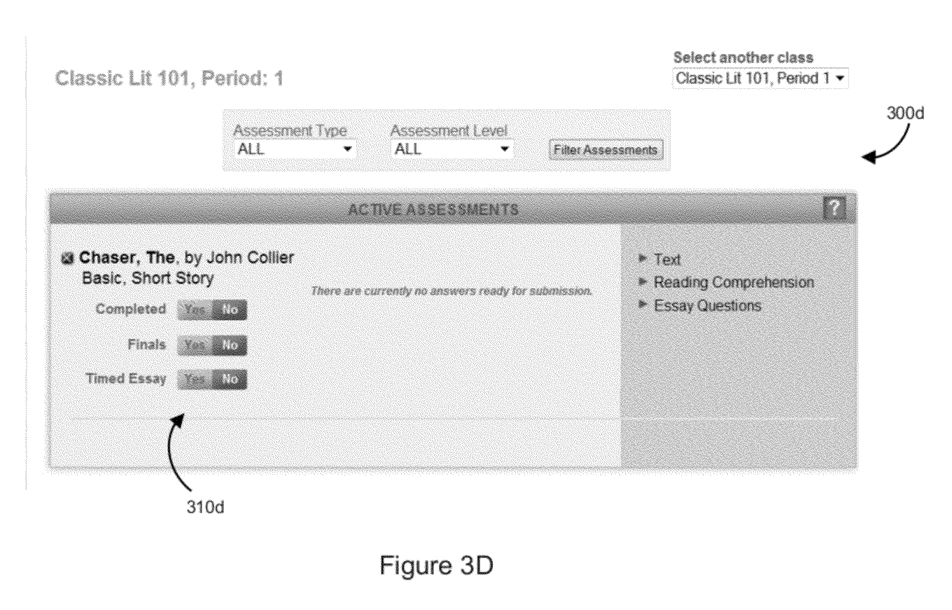

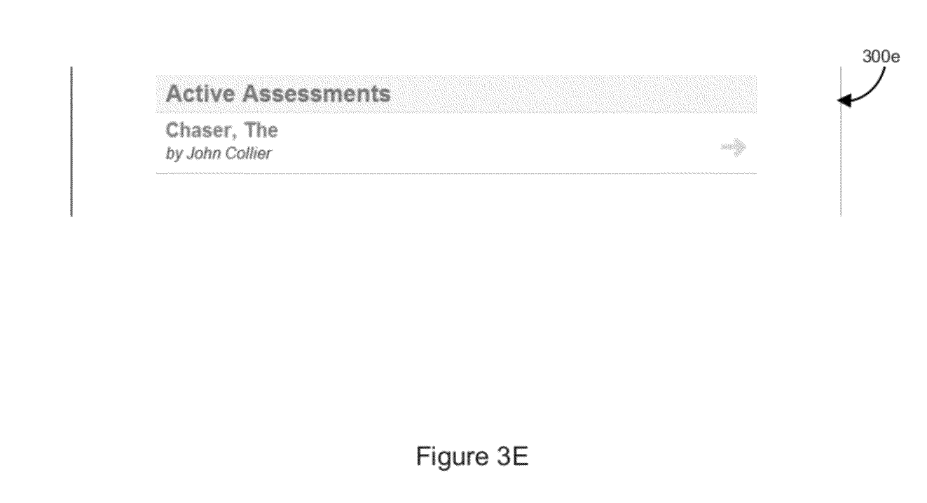

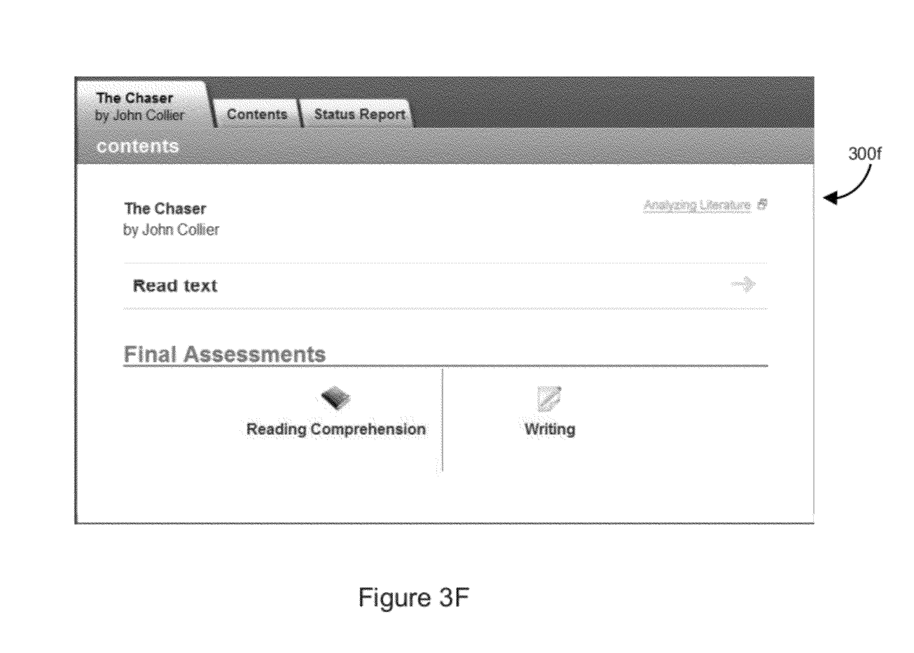

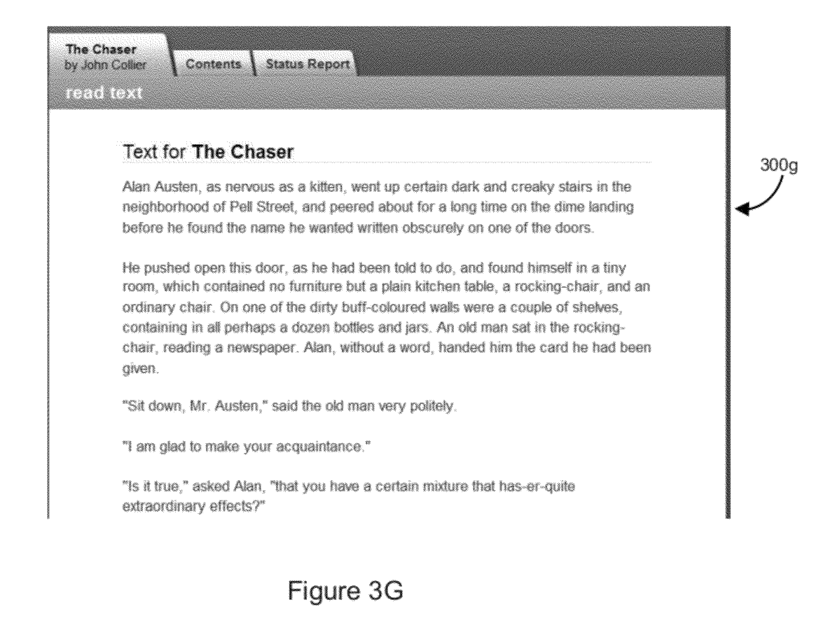

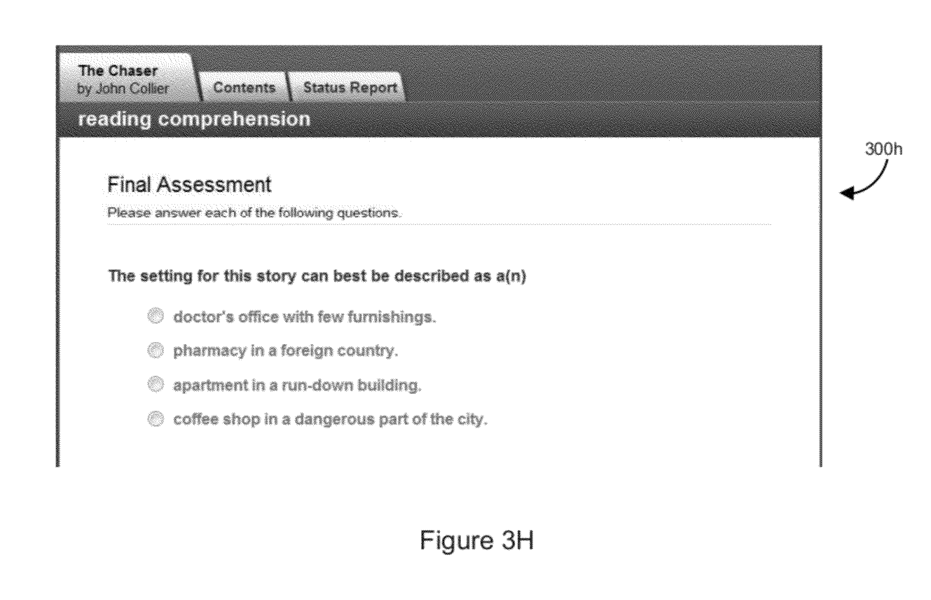

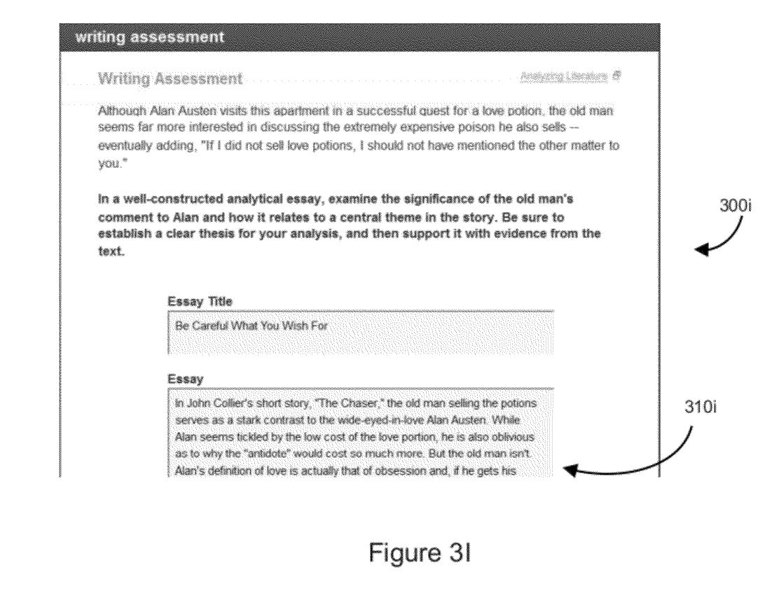

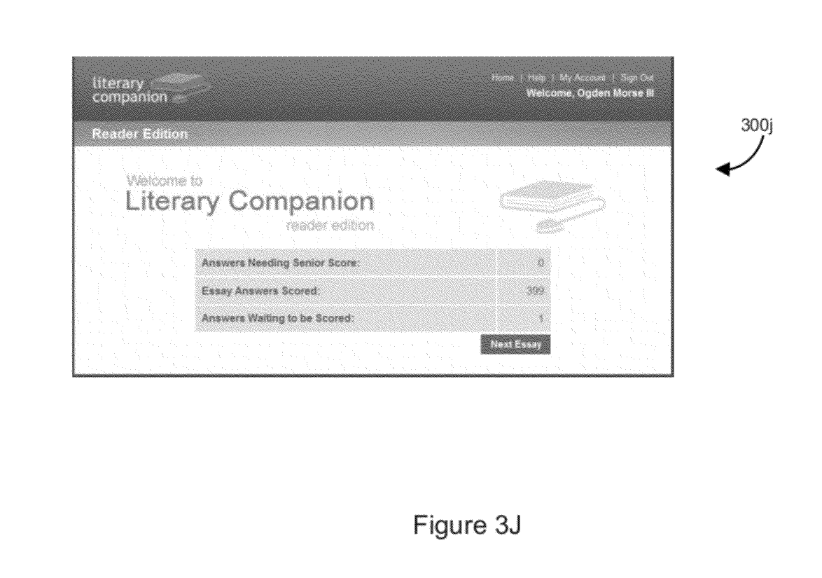

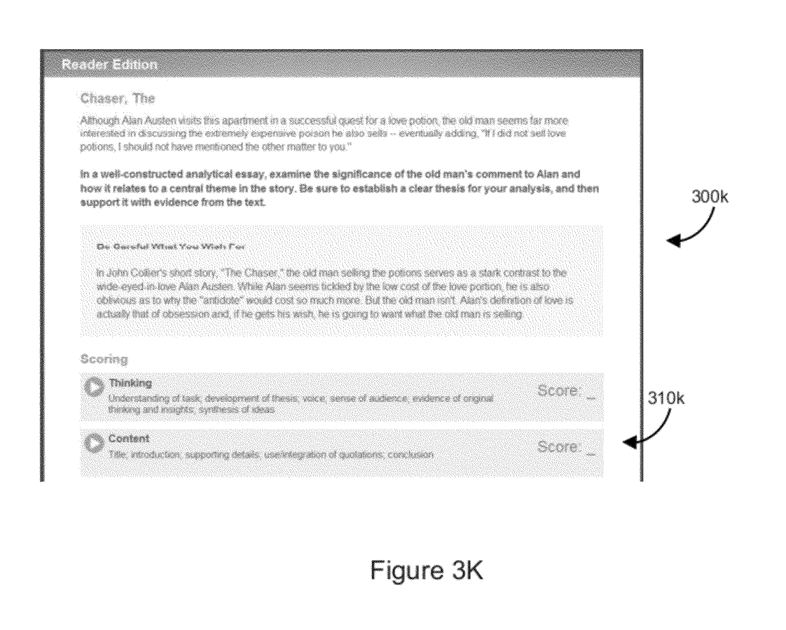

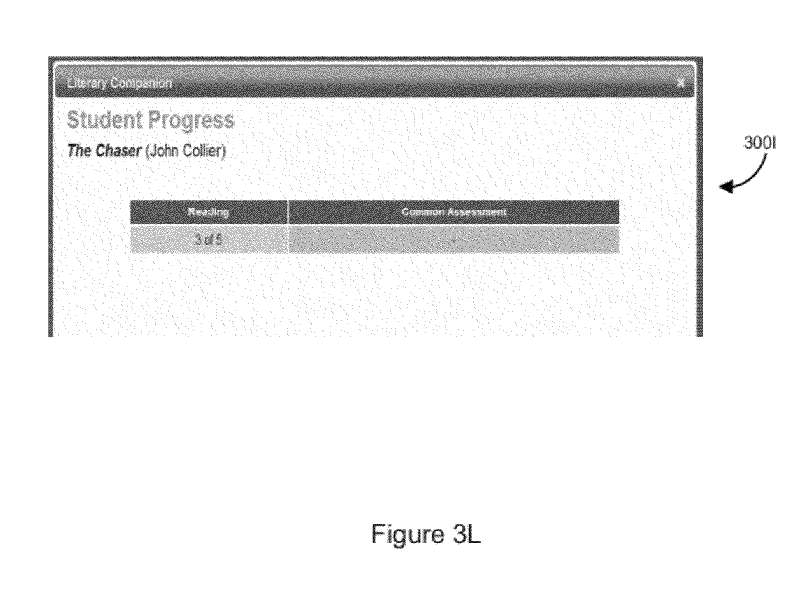

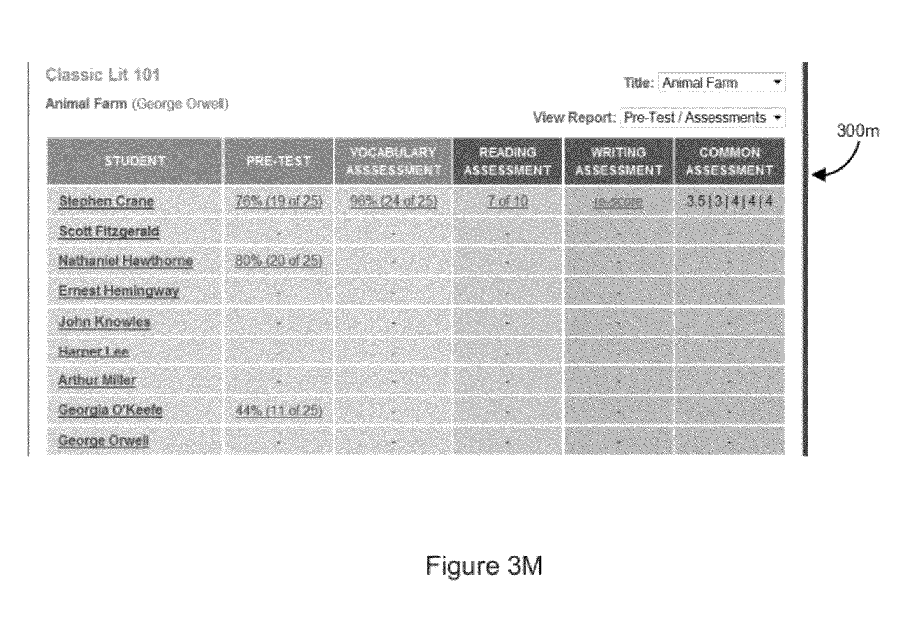

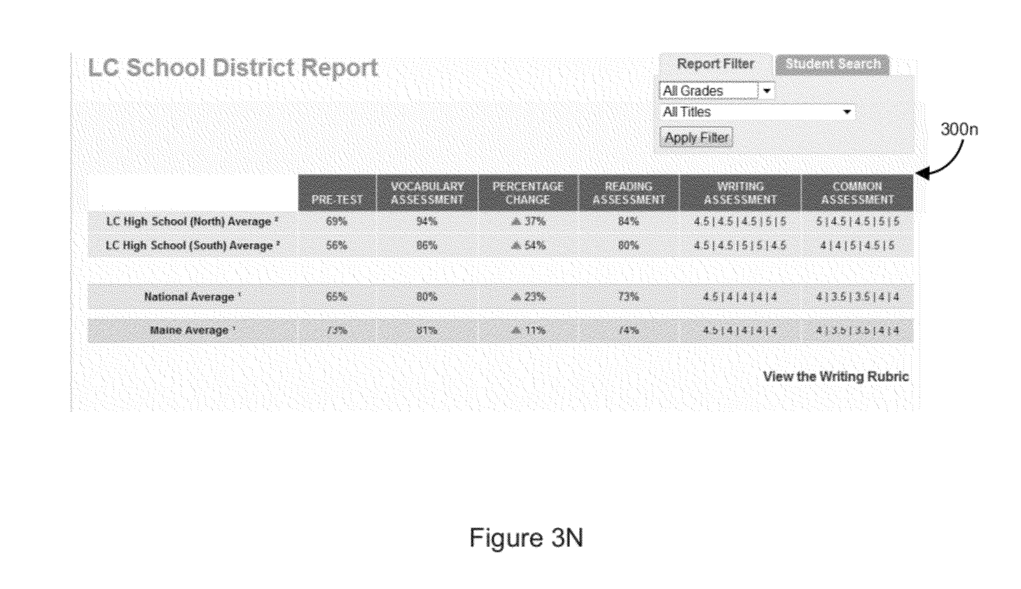

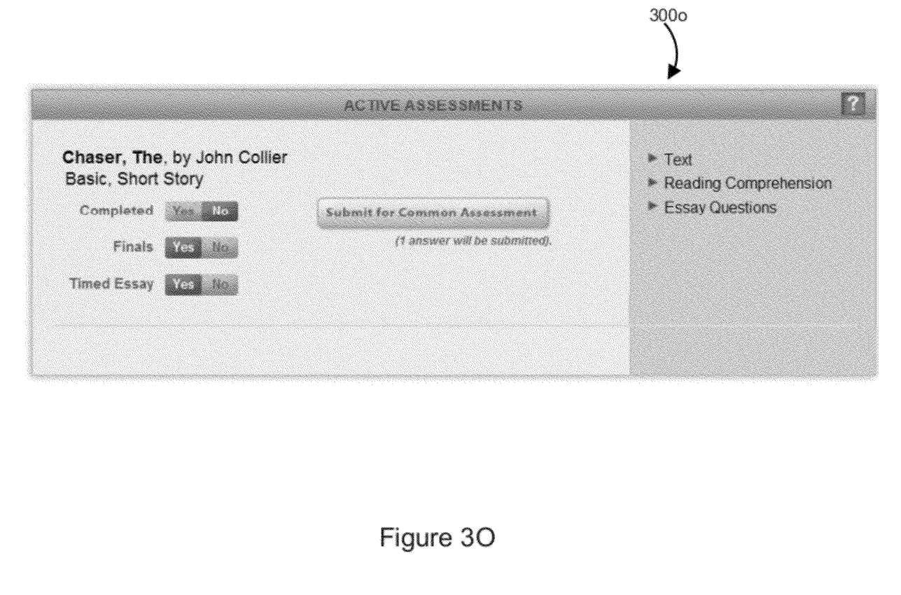

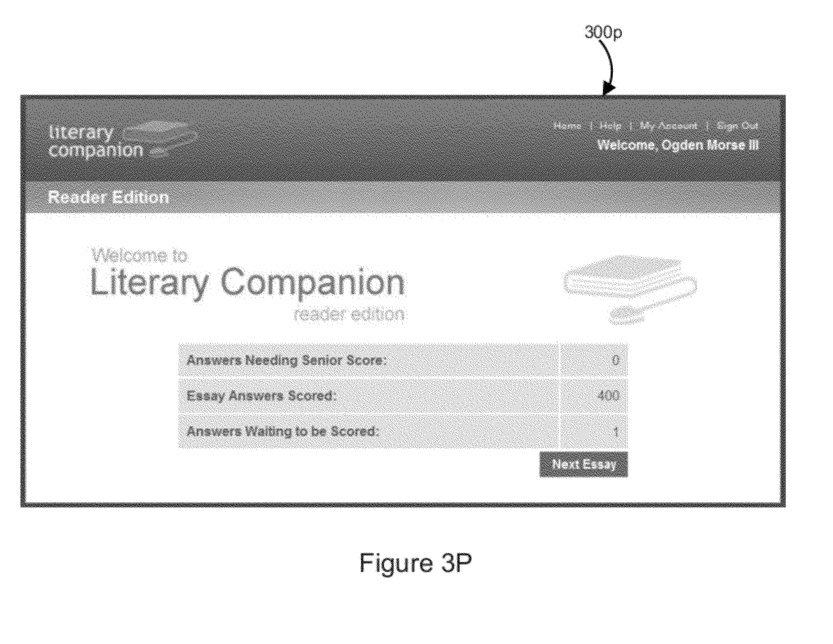

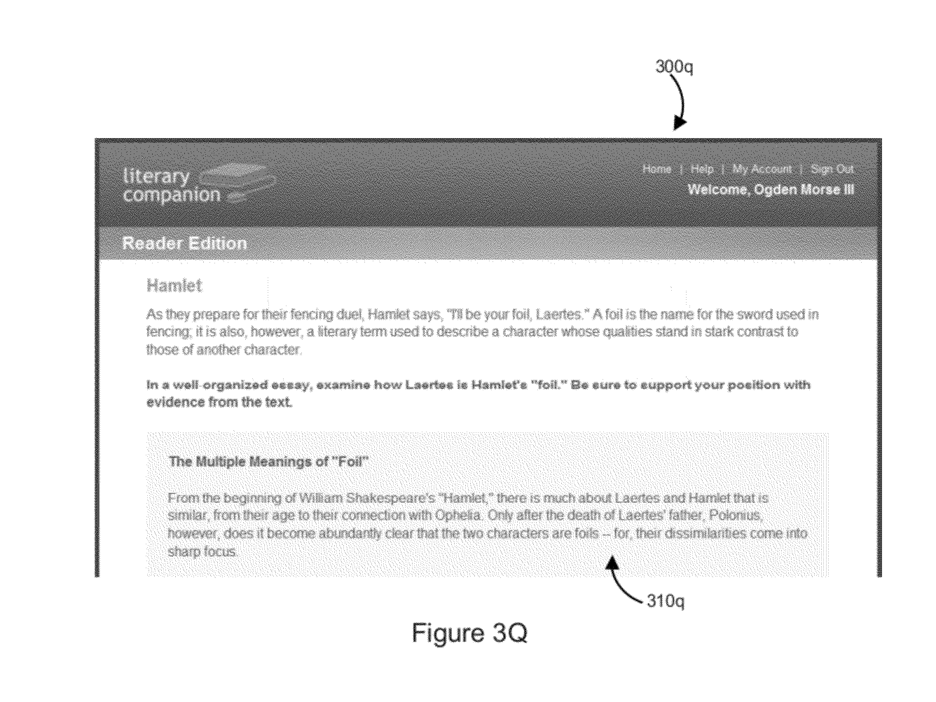

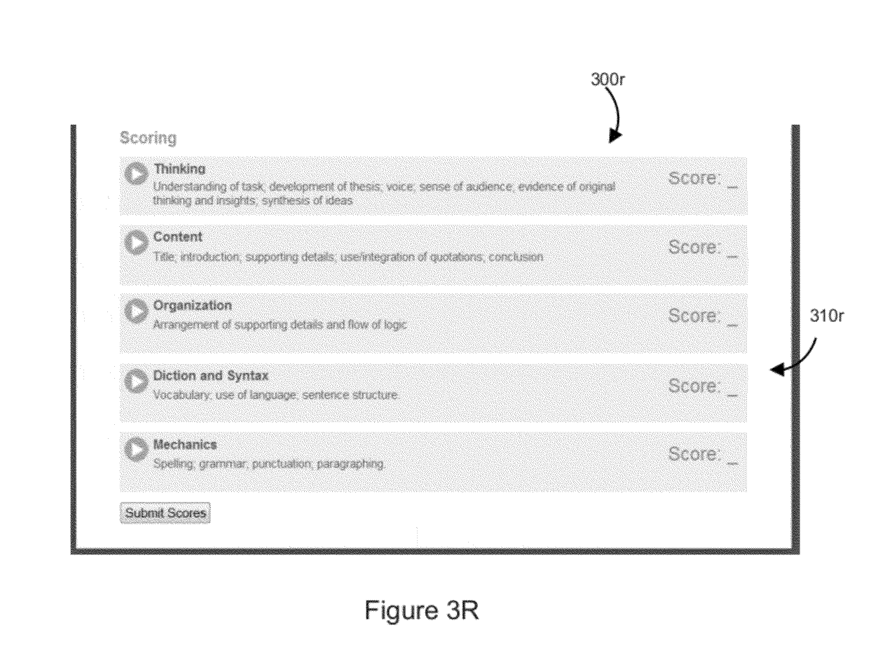

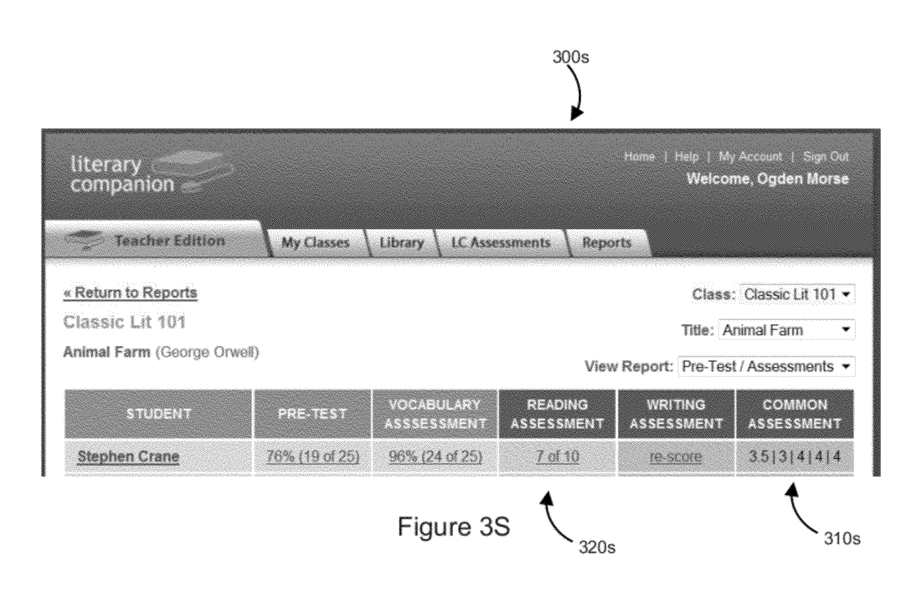

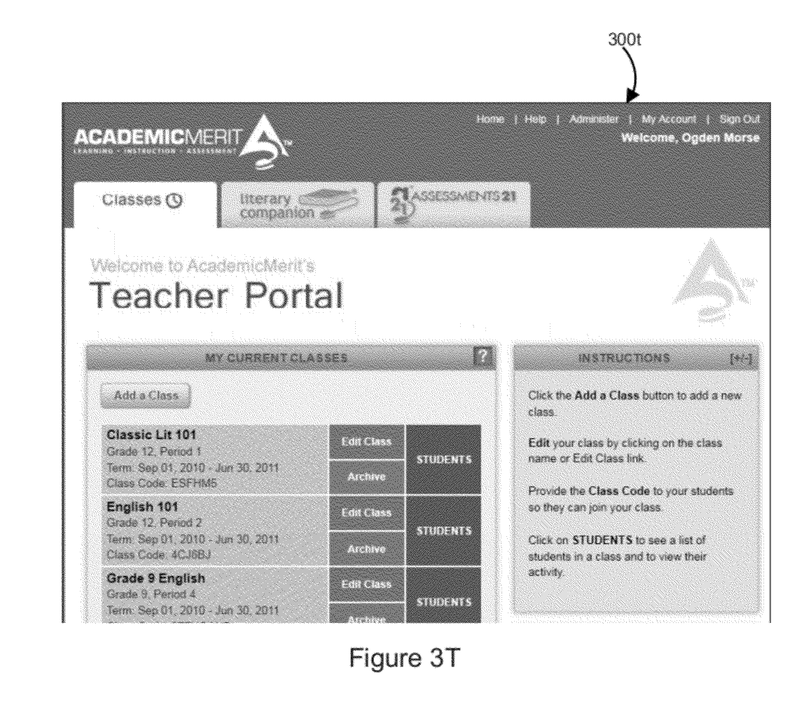

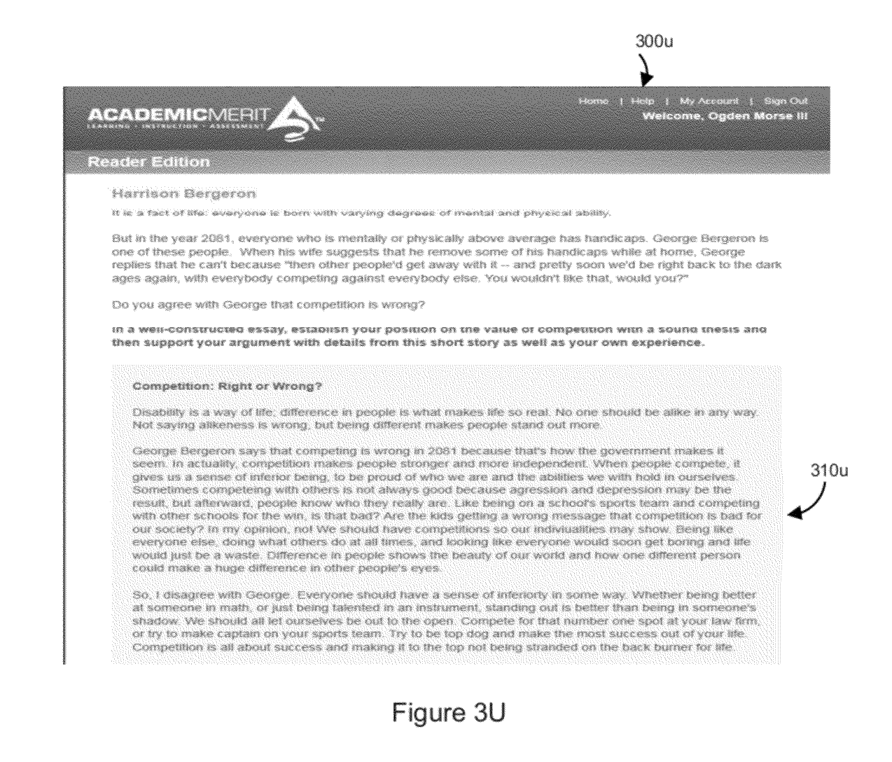

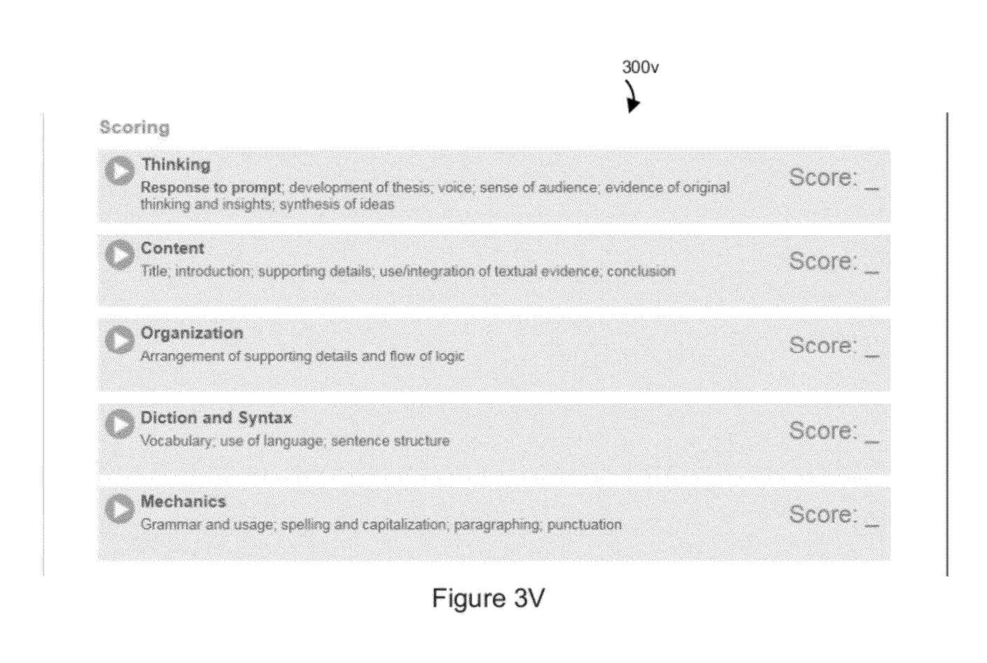

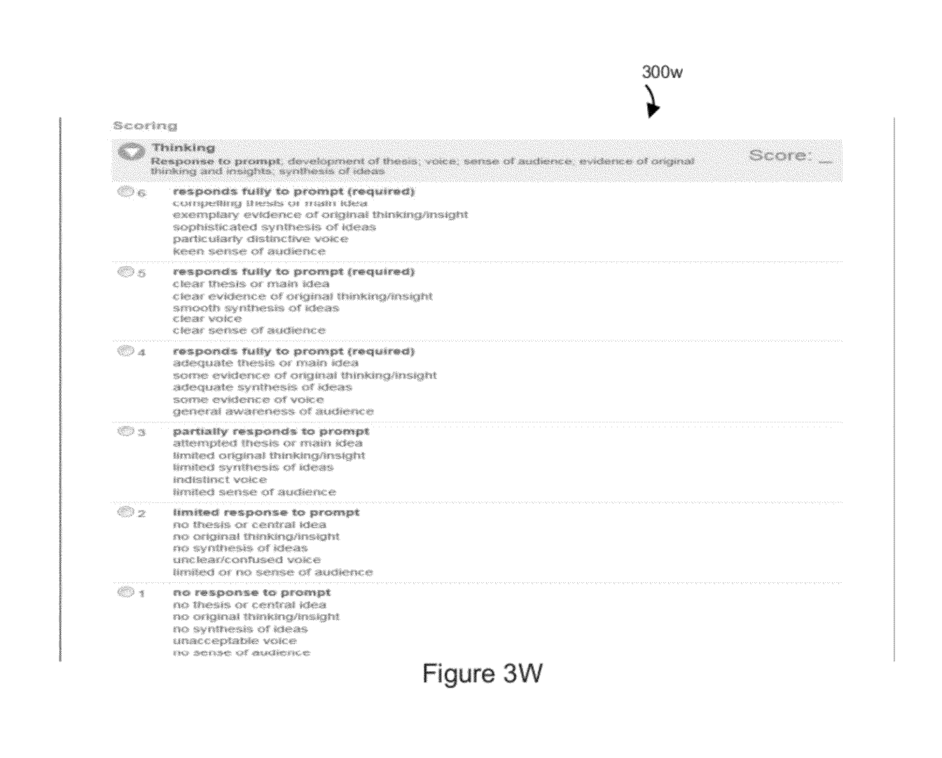

FIG. 3A illustrates a screenshot 300a of an exemplary login page for the technology. The user, utilizing a computing device, logs in to the AcademicMerit website to gain access to his/her classes and other information through the “Portal” (e.g., a teacher utilizes a “Teacher Portal” as illustrated in the process of FIG. 1A, a student utilizes a “Student Portal” as illustrated in the process of FIG. 1B).

FIG. 3B illustrates a screenshot 300b of an exemplary teacher selection of assessments. The teacher selection of assessments can, for example, include a selection of various types of assessment information (e.g., text, reading comprehension question associated with the text, an essay question associated with the text). The teacher, utilizing a computing device, clicks on a tab called “Assessments21” and uses a series of drop-down boxes to gain access to a library of texts (e.g., the process as illustrated in FIG. 1A). The texts are divided into three genres (short stories, poems, non-fiction) and three levels. The texts can include any number or types of genres, levels, and/or any other variations of organization.

FIG. 3C illustrates a screenshot 300c of an exemplary teacher selection of texts and questions (i.e., the selection of the assessment information). Upon gaining access to the library, the teacher, utilizing a computing device, browses the prospective texts, as well as the corresponding reading-comprehension questions and essay prompt (e.g., the process as illustrated in FIGS. 1A-1B).

FIG. 3D illustrates a screenshot 300d of an exemplary teacher selection of assessments. The teacher, utilizing a computing device, clicks the “Add to Class” button for a given text in order to assign that assessment to a given class (e.g., the process as illustrated in FIGS. 1A-1B). At that point, the teacher has access to buttons that control when the assessment is administered, when it is completed, when it should be submitted for scoring, and whether it is a timed essay (information that shapes the data). The student assessment server can automatically generate an assessment for each student based on the teacher's selection of assessment information.

Table 1 illustrates exemplary teacher selections of assessments for a plurality of classes.

TABLE 1

| Teacher | Class | Assessment Type | Assessment Level | Timed |
|---|---|---|---|---|
| A. Smith | English Comp. I, | Short Story | Basic | No |
| | Period 4 | | | |
| A. Smith | Writing 101, | Poem | Advanced | Yes - 1 hour |
| | Period 7 | | Placement | |
| L. McFly | Social Studies, | Magazine Article | Intermediate | Yes - 30 |
| | Period 3 | | | minutes |
| G. McFly | Special Studies | Chapter 10 of “When | Level 8 | No |
| | in History | Pigs Fly” Book | | |
| All | All Students | School History | Special | No |

FIG. 3E illustrates a screenshot 300e of an exemplary active assessment for a student. When the teacher activates the assessment, students in that class log in to the server via the AcademicMerit website, then select the “Assessments21” tab, where the assigned assessment appears 310 (e.g., the process as illustrated in FIG. 1B). In some examples, the students receive a plurality of assessments from various teachers and/or administrators (e.g., school-wide assessment, grade-wide assessment, etc.).

FIGS. 3F-3H illustrate screenshots 300f, 300g, and 300h of an exemplary student assessment (also referred to as an assessment). The students, utilizing computing devices, click on the designated assessment, and then are invited to “Read text.” After doing so—again, at the discretion/timing of the teacher—students gain access to five accompanying reading comprehension questions; upon answering those questions, the students hit the Submit button to submit the assessment responses (e.g., the process as illustrated in FIG. 1B). These answers (also referred to the assessment responses) are automatically scored by the technology as described herein. Although FIGS. 3F-3H illustrate an exemplary student assessment with a short story, multiple-choice questions, and an essay, a student assessment can include, for example, any type of text (e.g., poem, newspaper article, magazine article) and/or student response (e.g., short answer, multiple choice, fill-in the blank, long essay response, short essay response).

FIG. 31 illustrates a screenshot 300i of an exemplary student essay (part or all of an assessment response) as part of a writing assessment 310i. When the teacher grants access to the essay prompt, each student, utilizing a computing device,—in either a timed or non-timed scenario—writes an essay responding to it. Upon completion of the essay, each student hits the Submit button and the responses from the student are communicated to the student assessment server (e.g., the process as illustrated in FIG. 1B). The student assessment server receives the responses from the students in response to the assessment generated for the student and can associate the responses to the appropriate class and/or school.

FIGS. 3J-3K illustrate screenshots 300j and 300k of an exemplary scorer user interface. Each student's essay is sent into a database on a student assessment server (e.g., a web server controlled by AcademicMerit, a web server hosted by a school district). Using Centralized Online Scoring System (COSS) student scoring software, at least two readers, utilizing computing devices, score each essay in a double-blind system using at least a five-category rubric 310k (e.g., the process as illustrated in FIG. 1C). The student assessment server can generate and/or receive at least two preliminary scores, which are communicated to the student assessment server. The student assessment server can receive the preliminary scores and generate the analysis of the responses based on the preliminary scores. The student assessment server can automatically generate the assessment score (e.g., common assessment score, parts of the assessment score) based on the analysis (e.g., an analysis of the assessments, a third-party analysis of the assessments, an automatic analysis of the assessments).

FIG. 3L illustrates a screenshot 300l of an exemplary student progress. The resulting scores appear in each student's account.

FIG. 3M illustrates a screenshot 300m of an exemplary teacher review of scores (also referred to as assessment scores). The scores can be indicative of student performance. The teacher, utilizing a computing device, gains access to the resulting scores in the “Assessments21” section of the AcademicMerit Teacher Portal, where data for the entire class or individual student can be viewed by the teacher (e.g., the process as illustrated in FIG. 1C).

Table 2 illustrates exemplary scoring data available to the teachers and/or administrators. The scoring data can, for example, include various types of comparisons between students, classes, and/or teachers including, but not limited to, class comparison, income comparison, gender comparison, etc.

TABLE 2

| | Grades 1-3 | Grades 4-6 | Maximum | Minimum | Grades 1-6 |
|---|---|---|---|---|---|
| | Average | Average | Yearly | Yearly | Common |
| | Vocabulary | Vocabulary | Reading | Reading | Assessment |
| Student | Assessment | Assessment | Assessment | Assessment | Improvement |
| George McFly | 89% | 67% | 95% | 84% | +3 |
| Ed Lee | 76% | 70% | 72% | 64% | −1 |
| Norm Angels | 92% | 95% | 99% | 92% | +1 |
| Lee Smith | 65% | 89% | 86% | 82% | +2 |

In some examples, the student assessment server analyzes the scoring data (e.g., raw scoring data, processed scoring data) and automatically generates supplemental assessments based on the analysis of the scoring data (e.g., extra vocabulary assessments for underperforming students, extra reading assessments for students below a predefined threshold, extra writing assessment for the bottom 50% of students, etc.). The student assessment server can automatically and repeatedly generate the supplemental assessments (e.g., based on no improvements from the student, based on declines of the student's performance). In some examples, one or more storage devices (e.g., a database, a plurality of databases) store data associated with the scoring data. The student assessment server can, for example, utilize the stored data to generate the metric(s).

FIG. 3N illustrates a screenshot 300n of an exemplary administrator user interface. Designated administrators, utilizing a computing device, gain access to the resulting scores using AcademicMerit's Administrator Portal, where the scores for all students using the technology—in the school or district—can be viewed, and the data can be mined in a variety of ways to generate metrics (also referred to as scoring assessment metrics) (e.g., the process as illustrated in FIG. 1C).

Table 3 illustrates exemplary metrics available to the teachers and/or administrators. The metrics can, for example, include various types of comparisons (e.g., statistical analysis, averages) between students, classes, teachers, schools, and/or principals including, but not limited to, teacher comparison, principal comparison, gender comparison, etc.

TABLE 3

| | | | Reading | Writing | Common |
|---|---|---|---|---|---|
| | Common | Expected | Assessment | Assessment | Assessment |
| | Assessment | Improvement | Comparison | Comparison | Comparison |
| | Improvement | for next 2 | to Average | to Maximum | to National |
| Group | over 10 years | years | State Scores | State Scores | Average |
| Class A3 | +45% | +30 | +4% | +11% | +1 |
| Grade 3 | −5% | +1 | +2% | +15% | −4 |
| Grades 1-3 | +15% | +10 | +3% | +11% | +4 |
| School | +3% | +2 | +13% | +9% | +10 |

In some examples, the student assessment server analyzes the scoring data to generate a metric, which is a performance metric for classroom-based performance of a group of students. The metric can be, for example, associated with a class, a school, a grade, and/or any other sub-division of the school, district, and/or state population. The metric can be, for example, any type of analysis of the present scoring data, stored assessments scores, and/or historic scoring data (e.g., statistics, average, mean, mode). The student assessment server can, for example, automatically generate supplemental assessments and/or modify existing assessments based on the metrics (e.g., extra monthly assessment for 2^{nd} graders to track progress, movement from monthly to quarterly assessments for 3^{rd} graders based on metrics). The student assessment server can, for example, automatically and repeatedly generate the assessments for the students based on the selection of the assessment information and/or the metric.

FIG. 3O illustrates a screenshot 300o of an exemplary active assessment in the Teacher Portal. When students have completed the assigned essay, the students, utilizing a computing device, submit the essay to the student assessment server using the designated program. The student assessment server receives the assessments associated with the students from the respective student's computing devices. From the Teacher Portal, the teacher, utilizing a computing device, then clicks the Submit for Common Assessment button. Those essays (also referred to as assessments) are communicated to a database on the student assessment server. The student assessment server associates a programming code to each assessment for tracking the assessment through the scoring process. The student assessment server receives the assessments associated with the students from the respective student's computing devices.

FIG. 3P illustrates a screenshot 300p of an exemplary scorer user interface. An authorized reader, utilizing a computing device, of these essays logs in to the technology it with a username and password that designates him or her as a reader, the login is verified, and access to the server is granted. The reader can be, for example, authorized to score the assessments based on credentials (e.g., academic degrees, teaching certificates, etc.) and/or any other authorization criteria. When the reader reaches the welcome page, s/he is presented with multiple data, including the number of essays waiting to be scored. S/he clicks the Next Essay button to score the next essay in the queue. The student assessment server can automatically and randomly assign at least two scorers to each assessment. In some examples, the student assessment server analyzes information associated with each scorer (e.g., background, scoring criteria, credentials, etc.) to determine the assignment of the assessments to the scorers. In other examples, the student assessment server assigns the assessments to the scorers based on the assessments (e.g., length of assessment, complexity of assessment, etc.). Table 4 illustrates the assignment of assessments to scorers based on exemplary information.

TABLE 4

| Assessment | Scorer | Criteria A | Criteria B |
|---|---|---|---|
| Student ID A234 | J. Smith | English | Assessment |
| | | Grade 12 | Length >10,000 |
| | | | words |
| Student ID C223 | L. Jenkins | Social | Reading |
| | | Studies | Complexity <6 |
| | | Grade 8 | grade |
| Student ID RT234 | P. Edwards | French | NA |
| | | Level III | |
| Student ID HHJ2342 | H. Norse | Debate | Type = Pros/Cons |
| | | Level I | |

FIG. 3Q illustrates a screenshot 300q of an exemplary scorer review interface. The reader, utilizing a computing device, reaches a page that contains the name of the text, the writing prompt, and the student's essay 310q—but no identifying information about the student or the school.

FIG. 3R illustrates a screenshot 300r of an exemplary five-category rubric 310r. The reader, utilizing a computing device, reads the student's essay, then accesses COSS software's built-in five-category rubric, giving the student a score of 1-6 in each of the five categories (e.g., the process as illustrated in FIGS. 2A-2D). When all of the scores have been entered for the essay, the reader has the option of typing a short response intended for student and teacher in a specified field, then clicks on the Submit Scores button. Although FIG. 3R illustrates a five-category rubric, the assessments can be scored utilizing any type of scoring rubric/mechanism (e.g., ten-category rubric with a 1-10 for each category, three-category rubric with a A-F for each category, etc.).

The student assessment server receives the scored essay and stores the scored essay in a database. A second authorized reader, utilizing a computing device, logs in to server and clicks on Next Essay. In random order—i.e., not the same order as any other reader—essays appear for scoring. At some point, the essay scored by the first reader will appear on the second reader's screen. The second reader has no indication that the essay has been read previously. The reader scores said essay using the built-in rubric and clicks Submit Scores. The student assessment server receives the second scored essay and stores the scored essay in a database.

In some examples, additional readers can score the assessments. In these examples, the student assessment server receives at least two of the scored essays (also referred to as the scored assessments or the preliminary assessment scores).

The student assessment server compares the respective scores for the essay in question to determine if the respective scores match criteria (e.g., dynamically generated criteria, pre-defined criteria, etc.). If none of the respective scores in each of the five categories differs by more than 1 point, then the student assessment server averages the two scores in each category, the scores are deemed valid, and the student assessment server sends by the application back to the student, teacher, and school/district administrators.

In some examples, the student assessment server generates the criteria based on the preliminary assessment scores, stored assessment scores (e.g., previous assessments scores for a student, previous assessments scores from a scorer, etc.), and/or stored historical assessment statistics (e.g., high scorer status, low scorer status, average individual score compared to average group score, etc.). In some examples, the student assessment server generates the assessment score for each assessment based on the scored essays, additional scores from other scorers, and/or automatically generated scores (e.g., word count, sentence complexity).

FIG. 3S illustrates a screenshot of an exemplary assessment score. As illustrated in FIG. 3S, the assessment score (also referred to as common assessment) can include a plurality of preliminary assessment scores 310s (in this example, 3.5, 3, 4, 4, and 4) and/or can include scores for the individual components of the assessment 320s. The assessment score can be a performance score for classroom-based performance of a student and/or indicative of student performance. The assessment can include, for example, a text, a reading comprehension question, and/or an essay question.

If any of the respective scores in the five-category rubric differ by more than one point in any of the categories, the student assessment server transmits the assessment to one or more “senior readers” who will score it a third time. In some examples, the student assessment server utilizes any type of criteria to determine if the respective stores match or do not match. Tables 5-7 illustrate exemplary preliminary assessment scores or parts thereof, the criteria, and the determination by the student assessment server.

TABLE 5

| | Preliminary | Preliminary | | Determination |
|---|---|---|---|---|
| | Assessment | Assessment | | for Additional |
| Rubric Part | Score A | Score B | Criteria | Scoring |
| Thinking | 4 | 3.5 | Scores | No |
| | | | within 1 | |
| Content | 6 | 4 | Scores | Yes |
| | | | within 1.5 | |
| Organization | 5 | 4 | Scores | No |
| | | | within 2 | |
| Diction and | 5.5 | 4 | Scores | Yes |
| Syntax | | | within 1 | |
| Mechanics | 5 | 3.5 | Scores | Yes |
| | | | within 1 | |

TABLE 6

| | Preliminary | Preliminary | | Determination | Preliminary | Determination | Final |
|---|---|---|---|---|---|---|---|
| | Assessment | Assessment | | for Additional | Assessment | for Additional | Assessment |
| Rubric Part | Score A | Score B | Criteria | Scoring | Score C | Scoring | Sub-Scores |
| Thinking | 4 | 3.5 | Scores within 1 | No | NA | NA | 3.75 |
| Content | 6 | 4 | Scores within 1.5 | Yes | 5 | NA | 5 |
| Organization | 5 | 4 | Scores within 2 | No | NA | NA | 4.5 |
| Diction and | 5.5 | 4 | Scores within 1 | Yes | 5 | NA | 5.25 |
| Syntax | | | | | | | |
| Mechanics | 5 | 3.5 | Scores within 1 | Yes | 4.5 | NA | 4.75 |

| | |
|---|---|
| Final Assessment Score | 4.65 |

TABLE 7

| Preliminary | Preliminary | | Determination |
|---|---|---|---|
| Assessment | Assessment | | for Additional |
| Score A | Score B | Criteria | Scoring |
| 4 | 2 | Scores within 1 | Yes |
| 4 | 3 | Scores within 1 | No |
| 98 | 90 | Scores within 10% | No |
| A+ | B− | Scores within | Yes |
| | | 1 grade letter | |

If the scores of the senior reader do align (that is, e.g., are within one point in each category) with the scores of one of the first two readers, then the scores are deemed valid, and the scores are posted to the student, teacher, and school/district administrator accounts (e.g., the process as illustrated in FIG. 2D). If the scores of the senior reader do not align with the scores of one of the first two readers, then student assessment server communicates the assessment to a second senior reader, who reads and scores the essay. The two senior-reader scores are deemed the “official” scores and are averaged. Should the two sets of scores by the two senior readers not align, the process continues among senior readers until a valid set of scores can be achieved.

FIG. 3T illustrates a screenshot 300t of an exemplary “Teacher Portal” for the website. The teacher, utilizing a computing device, logs in to the AcademicMerit website to gain access to his/her classes and other information through the “Portal.” In some examples, the teacher logs in to the “Teacher Portal” of the AcademicMerit website and clicks on the “FineTune” tab (not shown).

In some examples, within the “FineTune” section of the Teacher Portal, the teacher clicks on the “Work with FineTune” button to access the functionality of the technology. In some examples, the clicking of the “FineTune” button by the teacher prompts a query to a database of student assessments that have been scored and commented on by AcademicMerit's internal scoring experts (as described herein). The student assessment server randomly selects an assessment and tracks the user and the selected essay. In some examples, the student assessment server selects an assessment based on development information associated with the teacher (e.g., teacher needs to work on scoring organization, teacher needs to work on scoring thinking).

FIG. 3U illustrates a screenshot 300u of an exemplary selected assessment response 310u (in this example, an essay) for scoring. As illustrated in FIG. 3U, the teacher is greeted by a screen that contains the name of a text, the writing prompt associated with it, and the essay selected during the database query.

FIG. 3V illustrates a screenshot 300v of an exemplary five-category rubric for scoring. As illustrated in FIG. 3V, the AcademicMerit's writing rubric, which contains five categories, is displayed with the selected essay illustrated in FIG. 3U (e.g., in a pop-up, next to the essay, below the essay). Although FIG. 3V illustrates a five-category rubric for scoring, the technology can utilize any type of rubric for scoring (e.g., ten-category rubric, one-category rubric).

FIG. 3W illustrates a screenshot 300w of an exemplary criteria scoring. As illustrated in FIG. 3W, within each scoring category, a set of criteria corresponds to a particular numerical score. Table 8 illustrates exemplary assessment scores.

TABLE 8

| | Teacher's |
|---|---|
| | Assessment |
| Rubric Part | Score |
| Thinking | 4 |
| Content | 6 |
| Organization | 5 |
| Diction and | 5.5 |
| Syntax | |
| Mechanics | 5 |

In some examples, the teacher scores the essay in the five categories described herein using the built-in rubric, and then hits the Submit button. The student assessment server receives the assessment scoring from a teacher's computing device. The scoring can be associated with the teacher by input of the teacher's identification code and/or by association to the teacher's login. The student assessment server queries the database to find the expert scores (also referred to as the pre-determined scores) and comments associated with the selected essay. For each category, the student assessment server compares the teacher's score with the experts' score (also referred to as a pre-determined score) to determine if the scores match exactly, deviate by one point (considered within the margin of error), and/or deviate by more than one point. In some examples, the student assessment server compares the teacher's score with the experts' score based on other criteria (e.g., within a percentage range, within an average range). Tables 9-10 illustrate exemplary comparison of the teacher's score and the experts' score.

TABLE 9

| | Teacher's | Experts' | |
|---|---|---|---|
| | Assessment | Assessment | |
| Rubric Part | Score | Score | Analysis |
| Thinking | 4 | 4 | No Further Thinking |
| | | | Assessments Needed |
| Content | 6 | 4 | Additional Content |
| | | | Assessments Needed |
| Organization | 5 | 5 | No Further Organization |
| | | | Assessments Needed |
| Diction and | 5.5 | 5 | No Further Diction and |
| Syntax | | | Syntax Assessments |
| | | | Needed |
| Mechanics | 5 | 5 | No Further Mechanics |
| | | | Assessments Needed |

TABLE 10

| | Teacher's | Experts' | |
|---|---|---|---|
| | Assessment | Assessment | |
| Rubric Part | Score | Score | Analysis/Comments |
| Thinking | 4 | 4 | Comments about Thinking |
| Content | 6 | 4 | Comments about Content |
| Organization | 5 | 5 | Comments about |
| | | | Organization |
| Diction and | 5.5 | 5 | Comments about Diction |
| Syntax | | | and Syntax |
| Mechanics | 5 | 5 | Mechanics |
| Total | 25.5 | 23 | Further Assessments |
| | | | Needed to Confirm |
| | | | Teacher Expertise |

After the teacher submits the score, the teacher is greeted by a graphic that contains three columns labeled as follows: “Your Score”, which shows the teacher's score for each category; “Our Score”, which shows the scores given to the essay by AcademicMerit experts; and “Explanation”, which provides explanations by the experts for the scores they gave the essay. The student assessment server can generate development (e.g., teacher needs more assessment in a certain category, teacher needs more assessments) based on the analysis of the teacher's score and the experts' score. If the teacher's score aligns with the experts' score exactly for a given category, the alignment is noted in that row; if the teacher's score deviates by one point (also referred to as the margin of error), the deviation is noted in that row; and if the score for any category deviates by more than one point, the deviation is noted in that row.

In some examples, if the score for any category deviates by more than one point and/or any other criteria, the student assessment server automatically and iteratively requests additional assessments for the teacher. The automatic and iterative process enables the technology to correct issues in the teacher's scoring, thereby reducing the time to train teachers based on criteria and increasing the efficiency of the training process. In some examples, the student assessment server provides focused information to teach the teacher how the technology scores sections based on the comparison the scores. For example, if the teacher deviates by more than one point for a category, the student assessment server provides an explanation on how the experts score the category.

The results (data) of the scoring exercise can be stored in the teacher's account (e.g., stored in a database, stored on a storage device), as well as in the account of any designated supervisor/administrator; in both cases, they—along with all other participating teachers in the school or district—can be accessed at any time. The teacher can repeat this process as often as desired, drawing from a database of student essays and/or student assessments.

In the “FineTune” section of the Teacher Portal, the teacher, utilizing a computing device, can click on the “Scoring-Calibration Assessment” button, which prompts the following process:

a. The teacher is greeted by introductory pages including instructions for taking the assessment, as well as other information.

b. The technology steps the teacher through the scoring process as described herein for a total of three essays.

c. After the scoring of the third essay, the teacher's scores on the three essays are calculated (e.g., average, summation, mean). If the teacher's scores meet the qualifications (e.g., industry-wide standard, district-wide standard), then the teacher is deemed an “approved reader” of student assessments using the technology.

In some examples, the rubric is substantially aligned with the Common Core, so by aligning their scores with the rubric, teachers are in effect advantageously aligning with the Common Core. Whereas, traditionally, teachers will grade an essay “holistically”—that is, giving it an overall grade (a B, say, or a 92)—the rubric requires teachers to examine an essay in five separate categories (in these examples, thinking, content, organization, diction/syntax, and mechanics). The technology advantageously provides the teachers with practice in using the rubric and, after a teacher has submitted the five scores for an essay, the technology provides a comparison of their scores vs. the expert scores, along with an explanation for the latter. The process of immediate reinforcement advantageously enables the teacher to increasingly calibrate his/her scores with the experts and/or the criteria.

In some examples, the technology informs a teacher if s/he is “calibrated” or “not calibrated” next to each rubric and/or subcategory. For example, a teacher is notified of a few “not calibrated” at the beginning of the calibration process, and then a steady stream of “calibrated.” Tables 11-13 illustrate an exemplary calibration process for a teacher. As illustrated in Tables 11-13, the technology can automatically and iteratively continue the calibration process until the teacher is calibrated.

TABLE 11
First Calibration Step for Teacher - First Assessment

| | Teacher's | Experts' | |
|---|---|---|---|
| | Assessment | Assessment | |
| Rubric Part | Score | Score | Analysis |
| Thinking | 4 | 4 | Calibrated |
| Content | 6 | 4 | Two Additional |
| | | | Assessments Needed |
| Organization | 5 | 5 | Calibrated |
| Diction and | 5.5 | 5 | One Additional |
| Syntax | | | Assessment Needed |
| Mechanics | 5 | 5 | Calibrated |

TABLE 12
Second Calibration Step for Teacher - Second Assessment

| | Teacher's | Experts' | |
|---|---|---|---|
| | Assessment | Assessment | |
| Rubric Part | Score | Score | Analysis |
| Thinking | 3 | 3 | Calibrated |
| Content | 4 | 5 | One Additional |
| | | | Assessment Needed |
| Organization | 5 | 5 | Calibrated |
| Diction and | 5 | 5 | Calibrated |
| Syntax | | | |
| Mechanics | 6 | 5 | One Additional |
| | | | Assessment Needed |

TABLE 13
Third Calibration Step for Teacher - Third Assessment

| | Teacher's | Experts' | |
|---|---|---|---|
| | Assessment | Assessment | |
| Rubric Part | Score | Score | Analysis |
| Thinking | 6 | 6 | Calibrated |
| Content | 4 | 4 | Calibrated |
| Organization | 4 | 4 | Calibrated |
| Diction and | 5 | 5 | Calibrated |
| Syntax | | | |
| Mechanics | 3 | 3 | Calibrated |

In some examples, the technology is an ongoing professional-development tool. For example, even after a teacher has become calibrated, s/he will have the option of “staying fresh” by working with the technology. In some examples, the assessment piece of the technology determines whether the teacher is “approved” under one or more criteria (e.g., district criteria, common criteria).

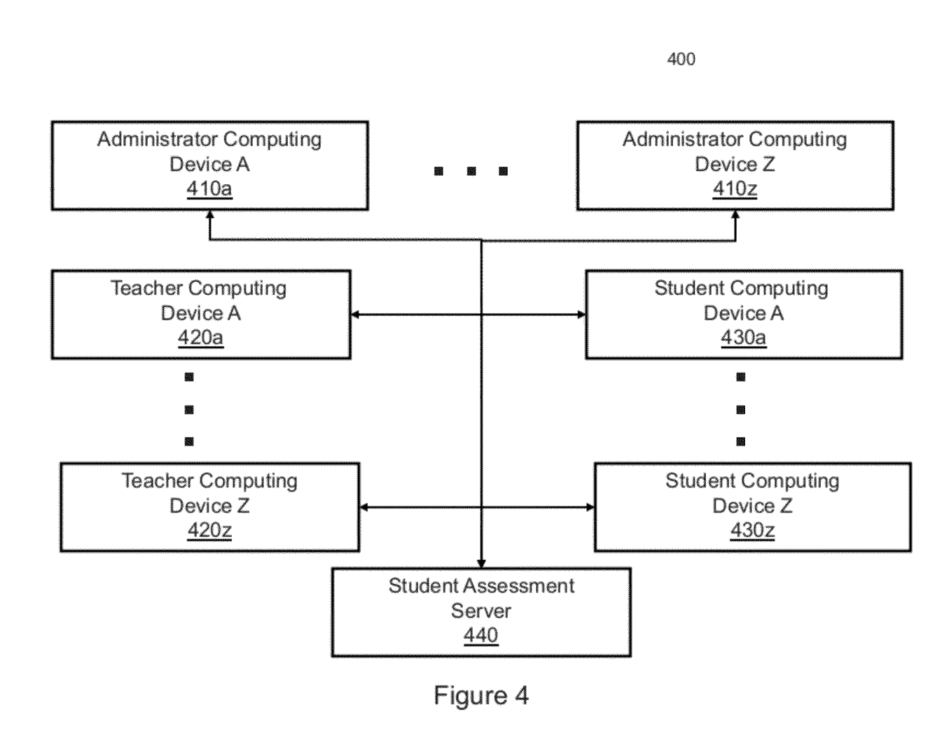

FIG. 4 is a block diagram 400 illustrating an exemplary configuration for assessing students. A plurality of administrator computing devices 410a through 410z (e.g., personal computing device, mobile computing device, etc.), teacher computing devices 420a through 420z, and/or student computing devices 430a through 430z can communicate (e.g., local area network, internet, etc.) with the student assessment server 440 (also referred to as the server).

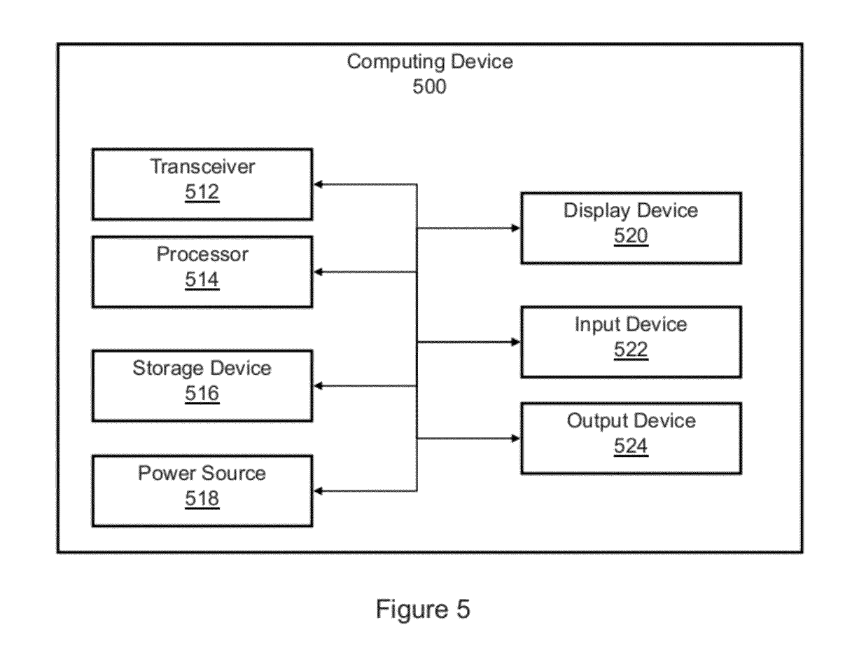

FIG. 5 illustrates an exemplary computing device 500 (e.g., student computing device, teacher computing device, administrator computing device, etc.). The computing device 500 includes a transceiver 512, a processor 514, a storage device 516, a power source 518, a display device 520, an input device 522, and an output device 524. The transceiver 512 transmits and/or receives information for the computing device 500. The processor 514 executes computer executable instructions. The storage device 516 stores information. The power source 518 provides power for the computing device 500. The display device 520 displays information. The input device 522 receives input for the computing device (e.g., keyboard, scanner). The output device 524 outputs information for the computing device (e.g., monitor, printer).

The modules and devices illustrated in FIG. 5 can, for example, utilize the processor 514 to execute computer executable instructions and/or include a processor 514 to execute computer executable instructions (e.g., an encryption processing unit, a field programmable gate array processing unit, etc.). It should be understood that the computing device 500 can include, for example, other modules, devices, and/or processors known in the art and/or varieties of the illustrated modules, devices, and/or processors.

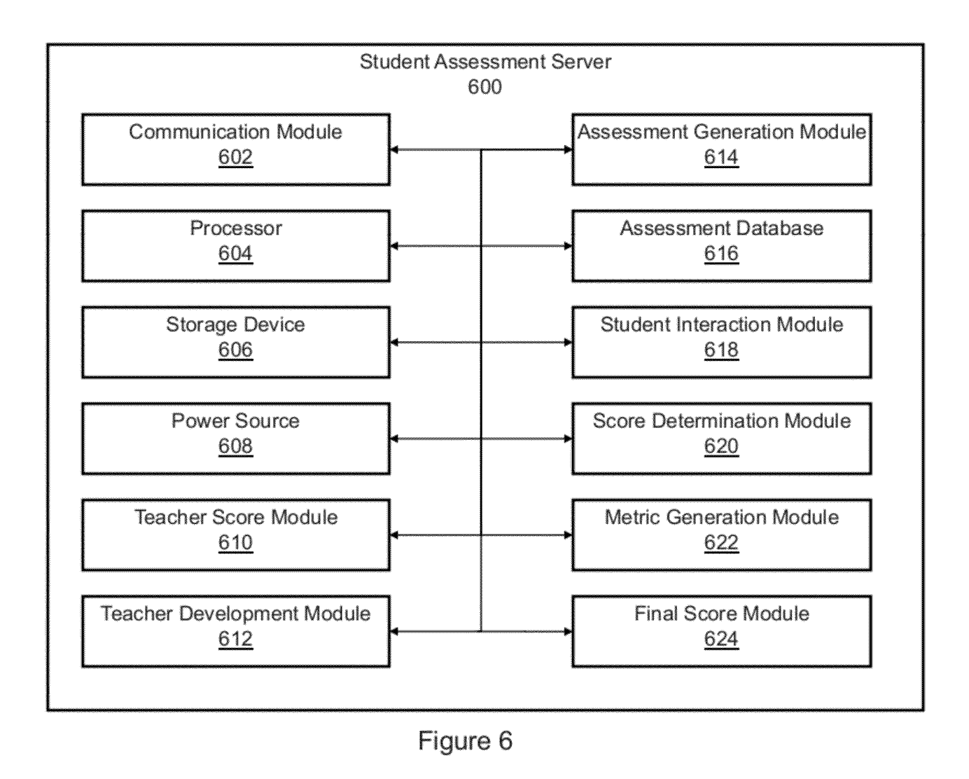

FIG. 6 illustrates an exemplary student assessment server 600. The student assessment server 600 includes a communication module 602, a processor 604, a storage device 606, a power source 608, a teacher score module 610, a teacher development module 612, an assessment generation module 614, an assessment database 616, a student interaction module 618, a score determination module 620, a metric generation module 622, and a final score module 624. The modules and devices illustrated in FIG. 6 and described herein can, for example, utilize the processor to execute computer executable instructions and/or include a processor to execute computer executable instructions (e.g., an encryption processing unit, a field programmable gate array processing unit, etc.). It should be understood that the student assessment server 600 can include, for example, other modules, devices, and/or processors known in the art and/or varieties of the illustrated modules, devices, and/or processors.

The communication module 602 (also referred to as transceiver) communicates data to/from the student assessment server 600. The processor 604 executes the operating system and/or any other computer executable instructions for the student assessment server 600 (e.g., web server, file transfer protocol server, etc.). The storage device 606 stores and/or retrieves data associated with the student assessment server 600 (e.g., student essays, scores, metrics, operating files, etc.). The storage device 606 can be, for example, any type of storage medium/device (e.g., random access memory, long-term storage device, optical device, etc.). The storage device can, for example, include a plurality of storage devices (e.g., school storage device A, district storage device C, etc.). The power source 608 provides power to the student assessment server (e.g., power transformer, battery, etc.).

The communication module 602 receives a plurality of assessment responses from the plurality of students in response to the generated assessment, transmits requests for at least two preliminary assessment scores for each of the plurality of assessment responses, receives at least two preliminary assessment scores for each of the plurality of assessment responses, and/or transmits a request for an additional preliminary assessment score for the assessment response if the at least two preliminary assessment scores match a criteria. In some examples, the communication module 602 transmits a request to the teacher for an additional assessment score of an additional student assessment based on the determination of the one of the at least two preliminary assessment score that matches the pre-determined assessment score, and/or receives the additional assessment score associated with the additional student assessment. In some examples, the additional assessment score is associated with the teacher.

The teacher score module 610 determines if the one of the at least two preliminary assessment scores associated with the teacher matches a pre-determined assessment score associated with the assessment response. In some examples, the teacher score module 610 determines if the additional assessment score associated with the additional student assessment matches a pre-determined assessment score associated with the additional student assessment.

The teacher development module 612 generates development information associated with the teacher based on the preliminary assessment score that matches the pre-determined assessment score. In some examples, the teacher development module 612 modifies the development information associated with the teacher based on the additional assessment score that matches the pre-determined assessment score.

The assessment generation module 614 generates an assessment for a plurality of students based on a selection of assessment information. The assessment database 616 stores assessments and/or assessment responses for the plurality of students. The student interaction module 618 interacts with students for the submission of assessments and/or assessment responses. The score determination module 620 determines if each of the at least two preliminary assessment scores for each of the assessment responses match the criteria.

The metric generation module 622 generates at least one scoring assessment metric based on the final assessment score for each of the assessment responses, one or more stored assessment scores, and/or one or more stored historical assessment statistics. The final score module 624 generates a final assessment score for each of the assessment responses based on the at least two preliminary assessment scores for each of the plurality of assessment responses, and/or the additional preliminary assessment score for each of the plurality of assessment responses. In some examples, one of the at least two preliminary assessment scores for each of the plurality of assessment responses is associated with a teacher (e.g., linked via the database entries, the database entries are linked to the teacher's identification code).

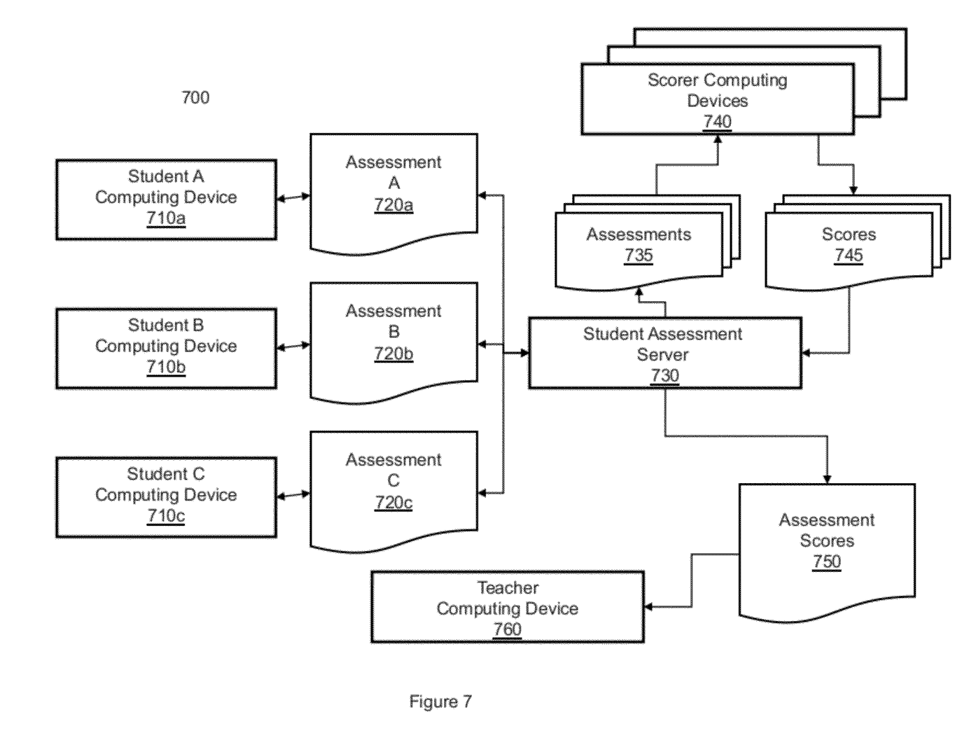

FIG. 7 is a flowchart 700 illustrating an exemplary method for assessment of student performance. A plurality of student computing devices A 710a, B 710b, and C 710c submit assessments A 720a, B 720b, and C 720c, respectively, to a student assessment server 730. The student assessment server 730 submits the assessments 735 to a plurality of scoring computing device 740. Scorers score the assessments and submit, utilizing the scorer computing devices 740, scores 745 to the student assessment server 730 (e.g., as illustrated in FIG. 3R). The student assessment server 730 processes the scores 745 and generates assessment scores 750. A teacher, utilizing the teacher computing device 760, views the assessment scores 750 (e.g., as illustrated in FIG. 3M).

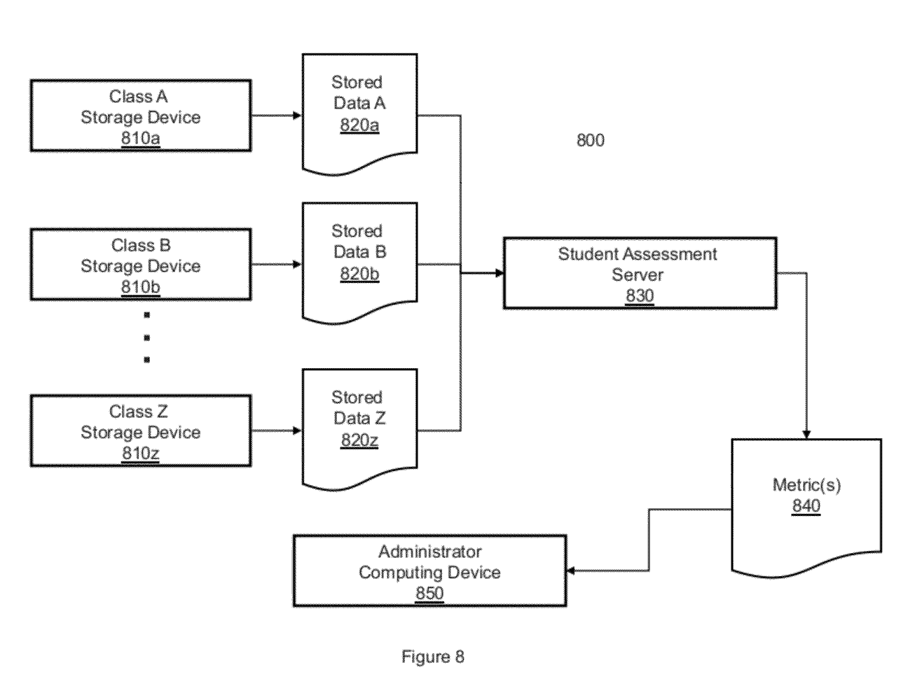

FIG. 8 is a flowchart 800 illustrating an exemplary method for generation of metric(s) based on student performance. Stored data A 820a, B 820b, and C 820c (e.g., classroom data, school data) is retrieved from a plurality of class storage devices A 810a, B 810b, and C 810c, respectively. The student assessment server 830 receives the stored data A 820a, B 820b, and C 820c and generates one or more metrics 840 based on the stored data A 820a, B 820b, and C 820c. An administrator, utilizing an administrator computing device 850, can access the one or more metrics 840 for analysis (e.g., as illustrated in FIG. 3N).

FIG. 9 is a flowchart 900 illustrating an exemplary scoring of student performance utilizing, for example, a student assessment server 440 of FIG. 4. The student assessment server 440 automatically generates (905) an assessment for a plurality of students based on a selection of assessment information (e.g., as illustrated in FIG. 3C). The student assessment server 440 receives (910) a plurality of assessment responses from the plurality of students in response to the generated assessment (e.g., as illustrated in FIG. 3I). The student assessment server 440 transmits requests for at least two preliminary assessment scores for each of the plurality of assessment responses. Scorers, utilizing computing devices, score (925 and 930) the assessments (e.g., as illustrated in FIG. 3K). The student assessment server 440 receives the two preliminary assessment scores for each of the plurality of assessment responses.

The student assessment server 440 determines (940) if each of the at least two preliminary assessment scores for each of the assessment responses match a criteria. If the at least two preliminary assessment scores for each of the assessment responses match (955) a criteria, the student assessment server 440 generates (950) the final assessment score (e.g., averages the preliminary assessment scores). If the at least two preliminary assessment scores for each of the assessment responses do not match (960) a criteria, the student assessment server 440 generates (970) and transmits a request for an additional preliminary assessment score for the assessment response. Another scorer, utilizing a computing device, scores (980) the assessment response. The student assessment server 440 continues the determination process (940). If the at least two preliminary assessment scores for each of the assessment responses match (955) a criteria, the student assessment server 440 generates (950) the final assessment score for each of the assessment responses based on the at least two preliminary assessment scores for each of the plurality of assessment responses, and/or the additional preliminary assessment score for each of the plurality of assessment responses.

FIG. 10 is a flowchart illustrating an exemplary scoring of teacher performance utilizing, for example, a student assessment server 440 of FIG. 4. The student assessment server 440 receives (1010) a preliminary assessment score associated with a teacher. The student assessment server 440 determines (1020) if the preliminary assessment scores associated with the teacher matches a pre-determined assessment score associated with the assessment response. If the preliminary assessment scores associated with the teacher matches (1030), a pre-determined assessment score associated with the assessment response, the student assessment server 440 generates (1040) a comparison score. If the preliminary assessment scores associated with the teacher does not match (1040), the student assessment server 440 generates (1050) development information associated with the teacher based on the preliminary assessment score that matches the pre-determined assessment score.

In some examples, the student assessment server transmits a request to the teacher for an additional assessment score of an additional student assessment based on the determination of the one of the at least two preliminary assessment score that matches the pre-determined assessment score. In some examples, the student assessment server receives the additional assessment score associated with the additional student assessment. The additional assessment score is associated with the teacher. In some examples, the student assessment server determines if the additional assessment score associated with the additional student assessment matches a pre-determined assessment score associated with the additional student assessment. In some examples, the student assessment server modifies the development information associated with the teacher based on the additional assessment score that matches the pre-determined assessment score.

In some examples, the final assessment score is a performance score for classroom-based performance of a student in the plurality of students. In some examples, the assessment comprises a text, at least one reading comprehension question associated with a text, and/or at least one essay question associated with a text.

In some examples, the student assessment server automatically generates at least one scoring assessment metric based on the final assessment score for each of the assessment responses, one or more stored assessment scores, and/or one or more stored historical assessment statistics. In some examples, the at least one scoring assessment metric is a performance metric for classroom-based performance of the plurality of students.

In some examples, the student assessment server automatically generates the assessment for the plurality of students based on the selection of assessment information and the at least one scoring assessment metric. In some examples, the student assessment server automatically generates the assessment for the plurality of students based on the selection of assessment information and at least one stored assessment score.

In some examples, each preliminary assessment score is received from a different scorer selected from a plurality of scorers. In some examples, the teacher is one of the different scorers selected from the plurality of scorers.

In some examples, the student assessment server automatically selects the different scorer from a plurality of scorers based on a plurality of assessments associated with each scorer of the plurality of scorers. In some examples, the student assessment server automatically and randomly selects the different scorer from a plurality of scorers based on the plurality of assessments. In some examples, the final assessment score includes a plurality of scores, each score associated with a part of the assessment.

In some examples, the student assessment server generates the criteria based on the at least two preliminary assessment scores for each of the assessment responses, one or more stored assessment scores, one or more stored historical assessment statistics, or any combination thereof.

In some examples, the technology for assessing student performance includes a method. The method includes receiving a selection of assessment information. The method further includes automatically generating an assessment for a plurality of students based on the selection of assessment information. The method further includes receiving a plurality of responses from the plurality of students in response to the generated assessment. The method further includes automatically generating at least one assessment score based on an analysis of the plurality of responses.

In some examples, the method further includes automatically generating at least one scoring assessment metric based on the at least one assessment score, one or more stored assessment scores, and/or one or more stored historical assessment statistics.

In some examples, the at least one scoring assessment metric is a performance metric for classroom-based performance of a group of students.

In some examples, the method further includes automatically generating the assessment for the plurality of students based on the selection of assessment information further comprises automatically and repeatedly generating the assessment for the plurality of students based on the selection of assessment information and the at least one scoring assessment metric.

In some examples, the method further includes automatically and repeatedly generating the assessment for the plurality of students based on the selection of assessment information and the at least one assessment score.

In some examples, the assessment includes a text, at least one reading comprehension question associated with the text, and/or at least one essay question associated with the text.

In some examples, the at least one assessment score is indicative of student performance.

In some examples, the method further includes receiving at least two preliminary scores for each of the plurality of responses and/or generating the analysis of the plurality of responses based on the at least two preliminary scores.

In some examples, the technology for assessing student performance includes a computer program product. The computer program product is tangibly embodied in an information carrier. The computer program product includes instructions being operable to cause a data-processing apparatus to perform the steps of any one of the aspects of the technology as described herein.

In some examples, the technology for assessing student performance includes a computerized method for assessing student performance. The method includes receiving, via a processor, a selection of assessment information. The method further includes automatically generating, via the processor, an assessment for a plurality of students based on the selection of assessment information. The method further includes receiving, via the processor, a plurality of responses from the plurality of students in response to the generated assessment. The method further includes automatically generating, via the processor, at least one assessment score based on an analysis of the plurality of responses.

In some examples, the technology for assessing student performance includes a system. The system includes a class information module configured to receive a selection of assessment information. The system further includes an assessment module configured to automatically generate an assessment for a plurality of students based on the selection of assessment information. The system further includes a student interaction module configured to receive a plurality of responses from the plurality of students in response to the generated assessment. The system further includes a scoring module configured to automatically generate at least one assessment score based on an analysis of the plurality of responses.

In some examples, the technology for assessing student performance includes a system. The system includes a means for receiving a selection of assessment information. The system further includes a means for automatically generating an assessment for a plurality of students based on the selection of assessment information. The system further includes a means for receiving a plurality of responses from the plurality of students in response to the generated assessment. The system further includes a means for automatically generating at least one assessment score based on an analysis of the plurality of responses.

In some examples, the technology for scoring student performance includes a method. The method includes receiving a plurality of assessments associated with a plurality of students. The method further includes receiving at least two preliminary assessment scores associated with the plurality of assessments. The method further includes determining if the at least two preliminary assessment scores match a criteria. The method further includes transmitting a request for an additional preliminary assessment score based on the determination if the at least two preliminary assessment scores match the criteria. The method further includes generating a final assessment score based on the at least two preliminary assessment scores, and/or the additional preliminary assessment score.

In some examples, each preliminary assessment score is received from a different scorer.

In some examples, the method further includes automatically selecting the different scorer from a plurality of scorers based on the plurality of assessments.

In some examples, the method further includes automatically and randomly selecting the different scorer from a plurality of scorers based on the plurality of assessments.

In some examples, the final assessment scores comprise a plurality of scores, each score associated with a part of the assessment.

In some examples, the final assessment score is a performance score for classroom-based performance of a student.

In some examples, the final assessment score is a measure of student performance.

In some examples, the assessment includes a text, at least one reading comprehension question associated with the text, and/or at least one essay question associated with the text.

In some examples, the method further includes generating the criteria based on the at least two preliminary assessment scores, one or more stored assessment scores, and/or one or more stored historical assessment statistics.

In some examples, the technology for scoring student performance includes a computer program product. The computer program product is tangibly embodied in an information carrier. The computer program product includes instructions being operable to cause a data-processing apparatus to perform the steps of any one of the aspects of the technology as described herein.

In some examples, the technology for scoring student performance includes a computerized method. The method includes receiving, via a processor, a plurality of assessments associated with a plurality of students. The method further includes receiving, via the processor, at least two preliminary assessment scores associated with the plurality of assessments. The method further includes determining, via the processor, if the at least two preliminary assessment scores match a criteria. The method further includes transmitting, via the processor, a request for an additional preliminary assessment score based on the determination if the at least two preliminary assessment scores match the criteria. The method further includes generating, via the processor, a final assessment score based on the at least two preliminary assessment scores, and/or the additional preliminary assessment score.

In some examples, the technology for scoring student performance includes a system. The system includes a student interaction module configured to receive a plurality of assessments associated with a plurality of students. The system further includes a scoring interaction module configured to receive at least two preliminary assessment scores associated with the plurality of assessments, and transmit a request for an additional preliminary assessment score based on a determination if the at least two preliminary assessment scores match a criteria. The system further includes a scoring module configured to determine if the at least two preliminary assessment scores match the criteria. The system further includes an assessment module configured to generate a final assessment score based on the at least two preliminary assessment scores, and/or the additional preliminary assessment score.

In some examples, the technology for scoring student performance includes a system. The system includes a means for receiving a plurality of assessments associated with a plurality of students. The system further includes a means for receiving at least two preliminary assessment scores associated with the plurality of assessments. The system further includes a means for determining if the at least two preliminary assessment scores match a criteria. The system further includes a means for transmitting a request for an additional preliminary assessment score based on the determination if the at least two preliminary assessment scores match the criteria. The system further includes a means for generating a final assessment score based on the at least two preliminary assessment scores, and/or the additional preliminary assessment score.

In some examples, the technology for scoring student performance includes a method. The method includes receiving a plurality of assessments associated with a plurality of students. The method further includes receiving at least two preliminary assessment scores associated with the plurality of assessments. The method further includes determining if the at least two preliminary assessment scores match a criteria. The method further includes transmitting a request for an additional preliminary assessment score based on the determination if the at least two preliminary assessment scores match the criteria. The method further includes generating a final assessment score based on the at least two preliminary assessment scores, and/or the additional preliminary assessment score.

In some examples, each preliminary assessment score is received from a different scorer.

In some examples, the method further includes automatically selecting the different scorer from a plurality of scorers based on the plurality of assessments.

In some examples, the method further includes automatically and randomly selecting the different scorer from a plurality of scorers based on the plurality of assessments.

In some examples, the final assessment scores comprise a plurality of scores, each score associated with a part of the assessment.

In some examples, the final assessment score is a performance score for classroom-based performance of a student.

In some examples, the final assessment score is a measure of student performance.

In some examples, the assessment includes a text, at least one reading comprehension question associated with the text, and/or at least one essay question associated with the text.

In some examples, the method further includes generating the criteria based on the at least two preliminary assessment scores, one or more stored assessment scores, and/or one or more stored historical assessment statistics.

In some examples, the technology for scoring student performance includes a computer program product. The computer program product is tangibly embodied in an information carrier. The computer program product includes instructions being operable to cause a data-processing apparatus to perform the steps of any one of the aspects of the technology as described herein.

In some examples, the technology for scoring student performance includes a computerized method. The method includes receiving, via a processor, a plurality of assessments associated with a plurality of students. The method further includes receiving, via the processor, at least two preliminary assessment scores associated with the plurality of assessments. The method further includes determining, via the processor, if the at least two preliminary assessment scores match a criteria. The method further includes transmitting, via the processor, a request for an additional preliminary assessment score based on the determination if the at least two preliminary assessment scores match the criteria. The method further includes generating, via the processor, a final assessment score based on the at least two preliminary assessment scores, and/or the additional preliminary assessment score.

In some examples, the technology for scoring student performance includes a system. The system includes a student interaction module configured to receive a plurality of assessments associated with a plurality of students. The system further includes a scoring interaction module configured to receive at least two preliminary assessment scores associated with the plurality of assessments, and transmit a request for an additional preliminary assessment score based on a determination if the at least two preliminary assessment scores match a criteria. The system further includes a scoring module configured to determine if the at least two preliminary assessment scores match the criteria. The system further includes an assessment module configured to generate a final assessment score based on the at least two preliminary assessment scores, and/or the additional preliminary assessment score.

In some examples, the technology for scoring student performance includes a system. The system includes a means for receiving a plurality of assessments associated with a plurality of students. The system further includes a means for receiving at least two preliminary assessment scores associated with the plurality of assessments. The system further includes a means for determining if the at least two preliminary assessment scores match a criteria. The system further includes a means for transmitting a request for an additional preliminary assessment score based on the determination if the at least two preliminary assessment scores match the criteria. The system further includes a means for generating a final assessment score based on the at least two preliminary assessment scores, and/or the additional preliminary assessment score.

In some examples, the technology for scoring teacher performance includes a method. The method includes receiving an assessment score associated with a student assessment, the assessment score associated with a teacher; determining if the assessment score associated with the student assessment matches a pre-determined assessment score associated with the student assessment; and generating development information associated with the teacher based on the determination of the assessment score.

In some examples, the method further includes transmitting a request for an additional assessment score of an additional student assessment based on the determination; receiving the additional assessment score associated with the additional student assessment, the additional assessment score associated with the teacher; determining if the additional assessment score associated with the additional student assessment matches a pre-determined assessment score associated with the additional student assessment; and modifying the development information based on the determination of the additional assessment score.

In some examples, the method further includes randomly selecting the student assessment from a plurality of student assessments.

In some examples, the method further includes selecting the student assessment from a plurality of student assessments based on development information associated with the teacher.

In some examples, the assessment score is a performance score for classroom-based performance of a student.

In some examples, the assessment includes a text, at least one reading comprehension question associated with the text, at least one essay question associated with the text, or any combination thereof.

In some examples, any of the method described herein can be automatically and iteratively performed, thereby advantageously enabling the technology to identify and/or prevent corrective development information to the teacher in an automated and cost-efficient manner.

In some examples, the technology for scoring student performance includes a computer program product. The computer program is tangibly embodied in an information carrier. The computer program product includes instructions being operable to cause a data processing apparatus to perform the steps of any of the technology described herein.

In some examples, the technology for scoring student performance includes a computerized method. The method includes receiving, via a processor, an assessment score associated with a student assessment, the assessment score associated with a teacher; determining, via the processor, if the assessment score associated with the student assessment matches a pre-determined assessment score associated with the student assessment; and generating, via the processor, development information associated with the teacher based on the determination of the assessment score.

In some examples, the technology for scoring student performance includes a system. The system includes a scoring interaction module configured to receive an assessment score associated with a student assessment, the assessment score associated with a teacher; and a scoring module configured to determine if the assessment score associated with the student assessment matches a pre-determined assessment score associated with the student assessment; and generate development information associated with the teacher based on the determination of the assessment score.

In some examples, the technology for scoring student performance includes a system. The system includes means for receiving an assessment score associated with a student assessment, the assessment score associated with a teacher; means for determining if the assessment score associated with the student assessment matches a pre-determined assessment score associated with the student assessment; and means for generating development information associated with the teacher based on the determination of the assessment score.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for student performance assessment, the method comprising:
automatically generating, via a processor, an assessment for a plurality of students based on a selection of assessment information;
receiving, via the processor, a plurality of assessment responses from the plurality of students in response to the generated assessment;
transmitting, via the processor, requests for at least two preliminary assessment scores for each of the plurality of assessment responses;
receiving, via the processor, at least two preliminary assessment scores for each of the plurality of assessment responses;
determining, via the processor, if each of the at least two preliminary assessment scores for each of the assessment responses match a criteria;
transmitting, via the processor, a request for an additional preliminary assessment score for the assessment response if the at least two preliminary assessment scores match the criteria; and
generating, via the processor, a final assessment score for each of the assessment responses based on the at least two preliminary assessment scores for each of the plurality of assessment responses, the additional preliminary assessment score for each of the plurality of assessment responses, or any combination thereof.

2. The method of claim 1, further comprising:
wherein one of the at least two preliminary assessment scores for each of the plurality of assessment responses is associated with a teacher;
determining if the one of the at least two preliminary assessment scores associated with the teacher matches a pre-determined assessment score associated with the assessment response; and
generating development information associated with the teacher based on the preliminary assessment score that matches the pre-determined assessment score.

3. The method of claim 2, further comprising:
transmitting a request to the teacher for an additional assessment score of an additional student assessment based on the determination of the one of the at least two preliminary assessment score that matches the pre-determined assessment score;
receiving the additional assessment score associated with the additional student assessment, the additional assessment score associated with the teacher;
determining if the additional assessment score associated with the additional student assessment matches a pre-determined assessment score associated with the additional student assessment; and
modifying the development information associated with the teacher based on the additional assessment score that matches the pre-determined assessment score.

4. The method of claim 1, wherein the final assessment score is a performance score for classroom-based performance of a student in the plurality of students.

5. The method of claim 1, wherein the assessment comprises a text, at least one reading comprehension question associated with a text, at least one essay question associated with a text, or any combination thereof.

6. The method of claim 1, further comprising automatically generating at least one scoring assessment metric based on the final assessment score for each of the assessment responses, one or more stored assessment scores, one or more stored historical assessment statistics, or any combination thereof.

7. The method of claim 6, wherein the at least one scoring assessment metric is a performance metric for classroom-based performance of the plurality of students.

8. The method of claim 6, wherein automatically generating the assessment for the plurality of students based on the selection of assessment information further comprises automatically generating the assessment for the plurality of students based on the selection of assessment information and the at least one scoring assessment metric.

9. The method of claim 1, wherein automatically generating the assessment for the plurality of students based on the selection of assessment information further comprises automatically generating the assessment for the plurality of students based on the selection of assessment information and at least one stored assessment score.

10. The method of claim 1, wherein each preliminary assessment score is received from a different scorer selected from a plurality of scorers.

11. The method of claim 10, wherein the teacher is one of the different scorers selected from the plurality of scorers.

12. The method of claim 10, further comprising automatically selecting the different scorer from a plurality of scorers based on a plurality of assessments associated with each scorer of the plurality of scorers.

13. The method of claim 12, wherein automatically selecting the different scorer from the plurality of scorers based on the plurality of assessments further comprises automatically and randomly selecting the different scorer from a plurality of scorers based on the plurality of assessments.

14. The method of claim 1, wherein the final assessment score comprise a plurality of scores, each score associated with a part of the assessment.

15. The method of claim 1, further comprising generating the criteria based on the at least two preliminary assessment scores for each of the assessment responses, one or more stored assessment scores, one or more stored historical assessment statistics, or any combination thereof.

16. A computer program product, tangibly embodied in an information carrier, the computer program product including instructions being operable to cause a data processing apparatus to:
generate an assessment for a plurality of students based on a selection of assessment information;
receive a plurality of assessment responses from the plurality of students in response to the generated assessment;
transmit requests for at least two preliminary assessment scores for each of the plurality of assessment responses;
receive at least two preliminary assessment scores for each of the plurality of assessment responses;
determine if each of the at least two preliminary assessment scores for each of the assessment responses match a criteria;
transmit a request for an additional preliminary assessment score for the assessment response if the at least two preliminary assessment scores match the criteria; and
generate a final assessment score for each of the assessment responses based on the at least two preliminary assessment scores for each of the plurality of assessment responses, the additional preliminary assessment score for each of the plurality of assessment responses, or any combination thereof.

17. A system for student performance assessment, the system comprising:
an assessment generation module configured to generate an assessment for a plurality of students based on a selection of assessment information;
a communication module configured to:
receive a plurality of assessment responses from the plurality of students in response to the generated assessment,
transmit requests for at least two preliminary assessment scores for each of the plurality of assessment responses,
receive at least two preliminary assessment scores for each of the plurality of assessment responses, and
transmit a request for an additional preliminary assessment score for the assessment response if the at least two preliminary assessment scores match a criteria;
a score determination module configured to determine if each of the at least two preliminary assessment scores for each of the assessment responses match the criteria; and
a final score module configured to generate a final assessment score for each of the assessment responses based on the at least two preliminary assessment scores for each of the plurality of assessment responses, the additional preliminary assessment score for each of the plurality of assessment responses, or any combination thereof.

18. The system of claim 17, further comprising:
wherein one of the at least two preliminary assessment scores for each of the plurality of assessment responses is associated with a teacher;
a teacher score module configured to determine if the one of the at least two preliminary assessment scores associated with the teacher matches a pre-determined assessment score associated with the assessment response; and
a teacher development module configured to generate development information associated with the teacher based on the preliminary assessment score that matches the pre-determined assessment score.

19. The system of claim 18, further comprising:
the communication module further configured to:
transmit a request to the teacher for an additional assessment score of an additional student assessment based on the determination of the one of the at least two preliminary assessment score that matches the pre-determined assessment score, and
receive the additional assessment score associated with the additional student assessment, the additional assessment score associated with the teacher;
the teacher score module further configured to determine if the additional assessment score associated with the additional student assessment matches a pre-determined assessment score associated with the additional student assessment; and
the teacher development module further configured to modify the development information associated with the teacher based on the additional assessment score that matches the pre-determined assessment score.

20. The system of claim 17, further comprising a metric generation module configured to generate at least one scoring assessment metric based on the final assessment score for each of the assessment responses, one or more stored assessment scores, one or more stored historical assessment statistics, or any combination thereof.
